(19) United States
(12) Patent Application Publication
(10) Pub. No.: US 2014/0073243 A1
(43) Pub. Date: Mar. 13, 2014

(54) WIRELESS COMMUNICATION SYSTEM AND WIRELESS COMMUNICATION APPARATUS

(71) Applicant: Renesas Electronics Corporation, Kawasaki-shi (JP)

(72) Inventors: Kenichiro HIJIOKA, Kawasaki-shi (JP); Koichi Yamaguchi, Kawasaki-shi (JP); Masaharu Matsudaira, Kawasaki-shi (JP)

(73) Assignee: Renesas Electronics Corporation, Kawasaki-shi (JP)

(21) Appl. No.: 13/968,281

(22) Filed: Aug. 15, 2013

(30) Foreign Application Priority Data
Sep. 7, 2012 (JP) 2012-197768

(51) Int. Cl. H04B 5/00

(52) U.S. Cl. CPC H04B 5/0012
USPC 455/41.1

(57) ABSTRACT

A first communication device includes a first coupling element and a second communication device includes a second coupling element. The first and second communication devices are configured to wirelessly transmit, between the first and second communication devices, a differential-mode signal and a common-mode signal simultaneously through non-contact coupling between the first and second coupling elements.

### CROSS-REFERENCE TO RELATED APPLICATIONS

This application is based upon and claims the benefit of priority from Japanese patent application No. 2012-197768, filed on Sep. 7, 2012, the disclosure of which is incorporated herein in its entirety by reference.

### BACKGROUND

A near-field wireless communication technique using non-contact coupling has been known. Examples of non-contact coupling include inductive coupling and capacitive coupling. Near-field wireless communication techniques using non-contact coupling have an advantage that a high bit-rate can be achieved in a limited transmission distance (e.g., several tens of micrometers to several centimeters). N. Miura et al. (“A High-Speed Inductive-Coupling Link With Burst Transmission”, IEEE JOURNAL OF SOLID-STATE CIRCUITS, VOL. 44, NO. 3, March 2009, pp. 947-955), T. Takeya et al. (“A 12 Gb/s Non-Contact Interface with Coupled Transmission Lines”, IEEE International Solid-State Circuits Conference, Digest of Technical Papers, 2011, pp. 492-494), and Y. Yoshida et al. (“A 2 Gb/s Bi-Directional Inter-Chip Data Transceiver With Differential Inductors for High Density Inductive Channel Array”, IEEE JOURNAL OF SOLID-STATE CIRCUITS, VOL. 43, NO. 11, November 2008, pp. 2363-2369) each discloses a communication system in which a baseband signal is transmitted through inductive coupling between a pair of inductors. Further, N. Miura et al., T. Takeya et al., and Y. Yoshida et al. each discloses a configuration in which a plurality of inductor pairs are disposed in order to perform unidirectional or bidirectional communication using multiple channels simultaneously.

Japanese Unexamined Patent Application Publication No. 2002-204272 discloses a two-wire communication system capable of simultaneously transmitting a differential-mode signal and a common-mode signal to a pair of signal lines (i.e., two-wire transmission line). Note that JP 2002-204272 A is intended for Digital Visual Interface (DVI), Low Voltage Differential Signal (LVDS), and the like. That is, in JP 2002-204272 A, both of the differential-mode signal and the common-mode signal, which are transmitted by using a pair of signal lines, are un-modulated baseband signals.

### SUMMARY

The present inventors have found a problem that near-field wireless communication systems disclosed in N. Miura et al., T. Takeya et al., and Y. Yoshida et al. need a plurality of inductor pairs in order to perform unidirectional or bidirectional multiple-channel communication. Disposing a plurality of inductor pairs could lead to, for example, an increase in the packaging size.

Further, it is conceivable to use a multiplexing technique such as time-division multiplexing and frequency-division multiplexing in order to perform unidirectional or bidirectional multiple-channel communication. However, there is a possibility that the use of such a multiplexing technique, in which resources such as time slots and frequencies are used exclusively by respective channels, could be a factor for hindering high-bit-rate communication because resources available for one channel is restricted.

Other problems to be solved and novel features of the present invention will be more apparent from the following descriptions of this specification and the accompanying drawings.

In an embodiment, first and second communication devices are configured to wirelessly transmit, between the first and second communication devices, a differential-mode signal and a common-mode signal simultaneously through non-contact coupling between first and second coupling elements.

According to the above-described embodiment, it is possible, in a wireless communication system using non-contact coupling of a coupling element pair, to perform unidirectional or bidirectional multiple-channel communication without requiring the use of a plurality of coupling element pairs and without requiring the resource division such as time-division multiplexing and frequency-division multiplexing.

### BRIEF DESCRIPTION OF THE DRAWINGS

The above and other aspects, advantages and features will be more apparent from the following description of certain embodiments taken in conjunction with the accompanying drawings, in which:

FIG. 1 shows a configuration example of a wireless communication system according to a first embodiment;

FIG. 2A is a diagram for explaining differential-mode transmission through a pair of coupling elements according to a first embodiment;

FIG. 2B is a diagram for explaining common-mode transmission through a pair of coupling elements according to a first embodiment;

FIG. 3A is a diagram for explaining differential-mode transmission through a pair of coupling elements according to a first embodiment;

FIG. 3B is a diagram for explaining common-mode transmission through a pair of coupling elements according to a first embodiment;

FIG. 4 shows a configuration example of a coupling element according to a first embodiment;

FIG. 5 is a graph showing an example of a differential-mode gain (Sdd21) and a common-mode gain (Scc21) of a pair of coupling elements according to a first embodiment;

FIG. 6 shows a configuration example of a wireless communication system according to a first embodiment;

FIG. 7 shows a configuration example of a common-mode transmitter according to a first embodiment;

FIG. 8 shows another configuration example of a common-mode transmitter according to a first embodiment;

FIG. 9 shows a configuration example of a common-mode receiver according to a first embodiment;

FIG. 10 shows another configuration example of a common-mode receiver according to a first embodiment;

FIG. 11 shows an application example of a wireless communication system according to a first embodiment;

FIGS. 12A and 12B show application examples of a wireless communication system according to a first embodiment;

FIG. 13 shows an application example of a wireless communication system according to a first embodiment;

FIG. 14 shows a configuration example of a wireless communication system according to a second embodiment;

FIG. 15 shows a configuration example of a wireless communication system according to a second embodiment;

FIG. 16 shows a configuration example of a wireless communication system according to a second embodiment;

FIG. 17 shows a configuration example of a wireless communication system according to a second embodiment;

FIGS. 18A to 18D show configuration examples of a communication device according to a second embodiment;

FIG. 19 shows a configuration example of a wireless communication system according to a third embodiment;

FIG. 20 is a sequence diagram showing an example of a transmission power control procedure according to a third embodiment;

FIG. 21 shows a configuration example of a wireless communication system according to a fourth embodiment;

FIG. 22 is a sequence diagram showing an example of a procedure for initiating communication according to a fourth embodiment;

FIG. 23 shows a configuration example of a wireless communication system according to a fourth embodiment;

FIG. 24 is a sequence diagram showing an example of a procedure for initiating communication according to a fourth embodiment;

FIG. 25 shows a configuration example of a communication device according to a fourth embodiment;

FIG. 26 shows a relation between transmission data transmitted in differential-mode and a carrier wave transmitted in common-mode in a wireless communication system according to a fifth embodiment;

FIG. 27 shows a relation between transmission data transmitted in differential-mode and a carrier wave transmitted in common-mode in a wireless communication system according to a fifth embodiment;

FIG. 28 shows a relation between transmission data transmitted in differential-mode and a carrier wave transmitted in common-mode in a wireless communication system according to a fifth embodiment;

FIG. 29 shows a configuration example of a wireless communication system according to a sixth embodiment; and

FIG. 30 shows a configuration example of a wireless communication system according to a sixth embodiment.

### DETAILED DESCRIPTION

Specific embodiments are explained hereinafter in detail with reference to the drawings. The same symbols are assigned to the same or corresponding components throughout the drawings, and their duplicated explanation is omitted as necessary for clarifying the explanation.

### First Embodiment

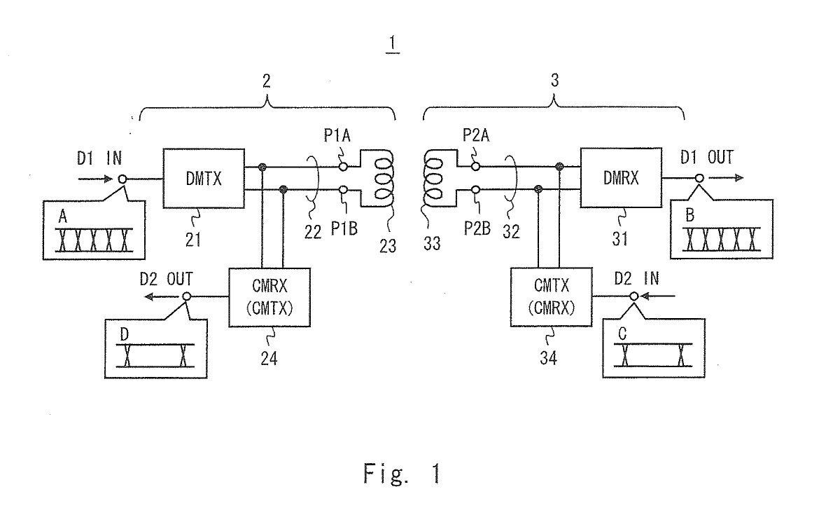

FIG. 1 shows a configuration example of a wireless communication system 1 according to this embodiment. The wireless communication system 1 includes two communication devices 2 and 3. The communication device 2 includes a differential-mode transmitter (DMTX) 21, a signal line pair 22, a coupling element 23, and a common-mode receiver (CMRX) 24. The communication device 3 includes a differential-mode receiver (DMRX) 31, a signal line pair 32, a coupling element 33, and a common-mode transmitter (CMTX) 34. The signal line pair 22 is connected to ports P1A and P1B at both ends of the coupling element 23, and the signal line pair 32 is connected to ports P2A and P2B at both ends of the coupling element 33. Details of the coupling elements 23 and 33 are explained later.

The communication devices 2 and 3 are configured to wirelessly transmit a differential-mode signal and a common-mode signal simultaneously through non-contact coupling formed between the pair of coupling elements 23 and 33. The pair of coupling elements 23 and 33 serves as both a transmitting and receiving coupler (or antenna) for transmitting a differential-mode signal and a transmitting and receiving coupler (or antenna) for transmitting a common-mode signal. The transmission directions of the differential-mode signal and the common-mode signal may be the same direction or opposite directions. Therefore, the wireless communication system 1 can perform unidirectional or bidirectional communication using multiple channels simultaneously through the non-contact coupling of the pair of coupling elements 23 and 33.

In the example shown in FIG. 1, the transmission directions of the differential-mode signal and the common-mode signal are opposite directions. That is, the differential-mode signal is transmitted from the communication device 2 to the communication device 3, and the common-mode signal is transmitted from the communication device 3 to the communication device 2. The DMTX 21 shown in FIG. 1 drives the signal line pair 22 and the coupling element 23 by a differential-mode signal into which a data signal D1 is encoded. The DMRX 31 receives the differential-mode signal through the coupling element 33 and the signal line pair 32 and restores the data signal D1. The CMTX 34 drives the signal line pair 32 and the coupling element 33 by a common-mode signal into which a data signal D2 is encoded. The CMRX 24 receives the common-mode signal through the coupling element 23 and the signal line pair 22 and restores the data signal D2. Signal waveforms A to ID shown in FIG. 1 represent specific examples of signal waveforms of the data signal D1 to be transmitted, the received data signal D1, the data signal D2 to be transmitted, and the received data signal D2 respectively.

The configuration example shown in FIG. 1 is a mere example. That is, as described previously, the transmission directions of the differential-mode signal and the common-mode signal may be the same direction. Further, the wireless communication system 1 may include a plurality of pairs of a DMTX and a DMRX for differential-mode transmission and may include a plurality of pairs of a CMTX and a CMRX for common-mode transmission.

Next, wireless transmission performed by the pair of coupling elements 23 and 33 and a configuration example of the pair of coupling elements 23 and 33 are explained hereinafter in detail. The coupling elements 23 and 33 are separated in terms of Direct Current (DC) and can transfer energy (or a signal) by non-contact coupling. In other words, the coupling elements 23 and 33 are coupled in terms of Alternating Current (AC) and can transfer energy by the AC coupling. The non-contact coupling between the coupling elements 23 and 33 includes at least one of inductive coupling and capacitive coupling, and more preferably includes both of inductive coupling and capacitive coupling. As described later, it is believed that when the coupling elements 23 and 33 are simultaneously driven by both of a differential-mode signal and a common-mode signal, the non-contact coupling between the coupling elements 23 and 33 exhibits characteristics of both of inductive coupling and capacitive coupling.

Between coupling elements forming inductive coupling, a magnetic field (or magnetic flux density) generated around a current flowing through one of the coupling elements (e.g., the coupling element 23) contributes to the energy transfer. Inductive coupling can be also called magnetic-field coupling or magnetic coupling. Specifically, when one of the coupling elements (e.g., the coupling element 23) is driven by a differential-mode signal, a current that varies with time according to the differential-mode signal flows through the one coupling element (e.g., the coupling element 23) and a magnetic field that varies with time is thereby generated around the one coupling element (e.g., the coupling element 23). Then, by disposing the other coupling element (e.g., the coupling element 33) within this time-varying magnetic field, an induced electromotive force that reflects the differential-mode signal is generated in the other coupling element (e.g., the coupling element 33). As a result, the differential-mode signal is transmitted from the one coupling element (e.g., the coupling element 23) to the other coupling element (e.g., the coupling element 33). For example, when the differential-mode signal to be transmitted is a differential baseband signal (i.e., a pulse-wave signal) such as a Non Return Zero (NRZ) signal and a Return Zero (RZ) signal, pulsatile voltage changes are energized in the other coupling elements (e.g., the coupling element 33) according to the time derivative of the AC current based on the differential baseband signal flowing through the one coupling elements (e.g., the coupling element 23). In this case, the DMRX 31 may restore the transmitted baseband signal (e.g., an NRZ signal) by detecting the energized pulsatile voltage changes.

In contrast to this, between coupling elements forming capacitive coupling, an electric field generated between two spatially-separated conductors (i.e., between two coupling elements) contributes to the energy transfer. Capacitive coupling is also called electric-field coupling. Specifically, one of the coupling elements (e.g., the coupling element 33) is driven by a common-mode signal through a signal line pair (e.g., the signal line pair 32). Note that it is believed that a signal line pair (e.g., the signal line pair 32) supplied with a common-mode signal behaves as if it is one signal line. Voltage changes in one of the coupling elements (e.g., the coupling element 33) according to the common-mode signal induce an alternating voltage in the other coupling element (e.g., the coupling element 23) by electrostatic induction. As a result, the common-mode signal is transferred to the other coupling element (e.g., the coupling element 23). For example, when the common-mode signal to be transmitted is a modulated carrier wave signal, the common-mode voltage on the other coupling element (e.g., the coupling element 23) changes according to the modulated carrier wave signal. In this case, the CMRX 24 may detect the common-mode voltage received by the other coupling element (e.g., coupling element 23) and then restore the data signal by performing demodulation processing on the received carrier wave signal.

As understood from the above-described qualitative consideration, the differential-mode signal is transmitted mainly by the inductive coupling between the coupling elements 23 and 33 and the common-mode signal is transmitted mainly by the capacitive coupling between the coupling elements 23 and 33. Therefore, it is desirable that specific form and arrangement of the coupling elements 23 and 33 should be determined so that both the inductive coupling for the differential-mode transmission and the capacitive coupling for the common-mode transmission are effectively formed. Specific examples of form and arrangement of the coupling elements 23 and 33 suitable for the wireless communication system 1 according to this embodiment are explained hereinafter.

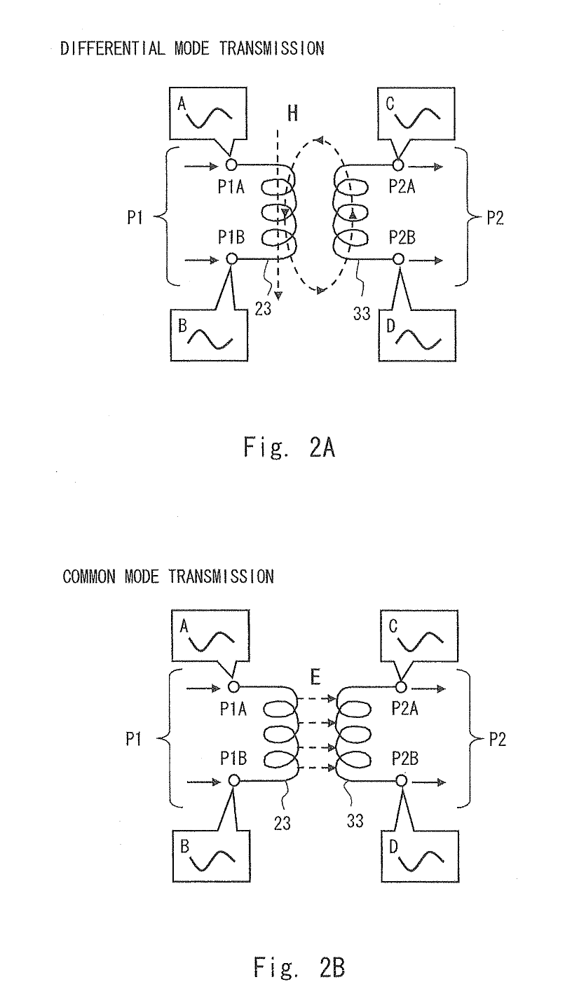

In an example, as shown in FIGS. 2A and 2B, each of the coupling elements 23 and 33 may be an inductor including a conductive loop, and more specifically, may be a coil. FIGS. 2A and 2B show an example in which the differential-mode signal and the common-mode signal are transmitted in the same direction. Regarding differential-mode transmission, a transformer structure is formed by the coupling elements 23 and 33 as shown in FIG. 2A. Specifically, the ports P1A and P1B at both ends of the coupling element 23 (i.e., a conductive loop or a coil) are driven by two signals having mutually opposite phases and constituting a differential-mode signal. Note that, the port in which the ports P1A and P1B are used as mixed ports is referred to as “P1”. Signal waveforms A and B shown in FIG. 2A represent a differential-mode signal to be input to the port P1. In this way, a magnetic field H (or magnetic flux density B) that passes through the conductive loop or coil arises, and then an induced electromotive force is generated between the ports P2A and P2B at both end of the coupling element 33 (i.e., a conductive loop or a coil) so as to hinder the change of the magnetic field H (or a magnetic flux) that occurs according to the current based on the differential-mode signal. Note that, the port in which the ports P2A and P2B are used as mixed ports is referred to as “P2”. Signal waveforms C and D shown in FIG. 2A represent a differential-mode signal output from the port P2.

Regarding common-mode transmission, the ports P1A and P1B at both ends of the coupling element 23 are driven by two signals having the same phase and constituting a common-mode signal as shown in FIG. 2B. Signal waveforms A and B shown in FIG. 2B represent a common-mode signal to be input to the port P1. In this way, the voltage on the coupling element 23 changes according to the common-mode signal and the voltage on the coupling element 33 also changes according to the common-mode signal. Signal waveforms C and D shown in FIG. 2B represent a common-mode signal output from the port P2. Therefore, it is possible to extract the common-mode signal from the ports P2A and P2B at both ends of the coupling element 33.

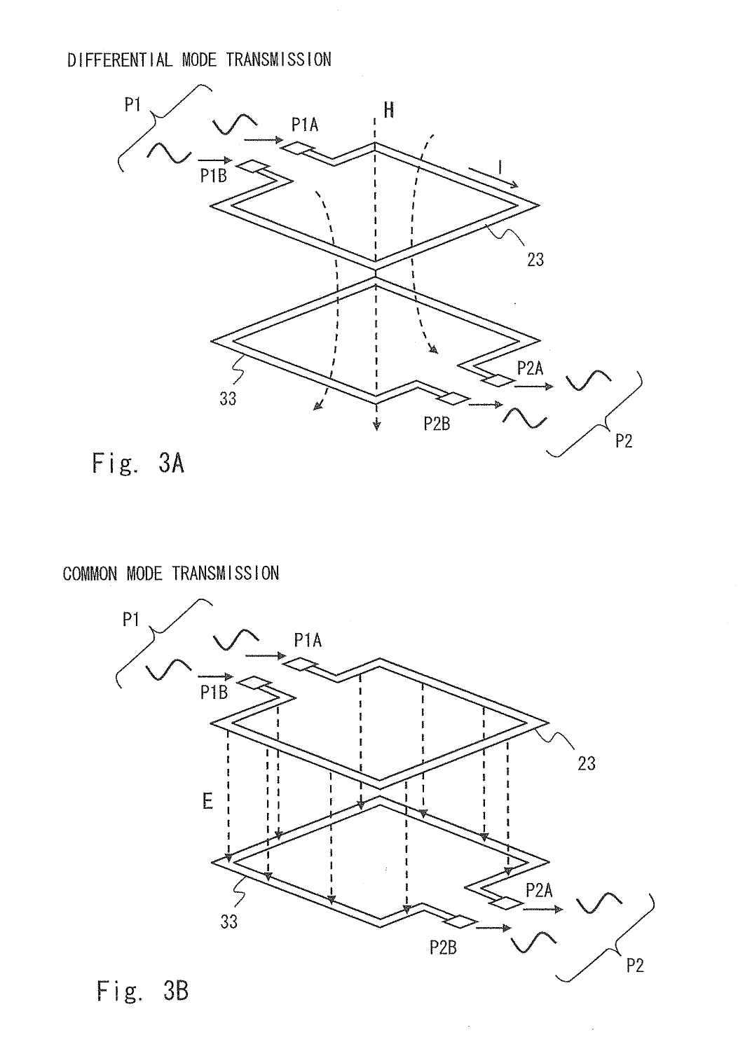

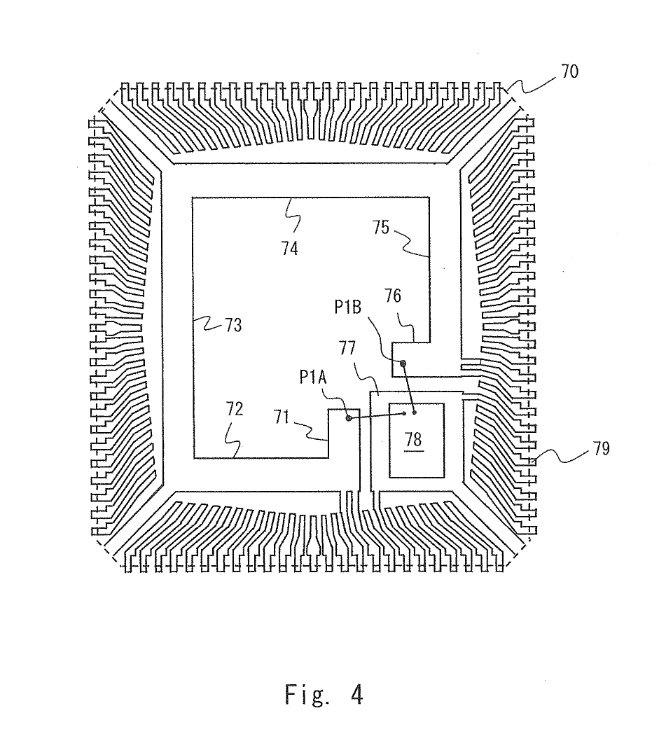

In another example, as shown in FIGS. 3A and 3B, each of the coupling elements 23 and 33 may be an inductor including a conductive loop and may be arranged so that their conductive loops face each other. In FIGS. 3A and 3B, each of the coupling elements 23 and 33 can be regarded as a one-turn coil. As understood from FIG. 3A, by the facing arrangement of the two conductive loops, the magnetic field H (or a magnetic flux), which is generated by the current flowing through the coupling element 23, goes through the conductive loop of the coupling element 33 with efficiency, and thus contributing to an improvement of differential-mode gain (or a transfer coefficient) from the coupling element 23 to the coupling element 33. Further, as understood from FIG. 3B, it is possible to increase a capacitive coupling coefficient between the coupling elements 23 and 33 by arranging the two conductive loops constituting the coupling elements 23 and 33 to face each other at an equal distance.

To be more precise, each conductive loop has an axial-symmetric shape in the example shown in FIGS. 3A and 3B. The axial-symmetric shape contributes to an improvement in transmission quality of the differential-mode signal and the common-mode signal. That is, by adopting an axial-symmetric shape, it is possible to improve the symmetry of the differential-mode signal and the symmetry of the common-mode signal. Therefore, for example, even when communication is performed at a high bit-rate, data can be transmitted with high accuracy.

Further, in the example shown in FIGS. 3A and 3B, the two conductive loops (coupling elements 23 and 33) are arranged so that a plane containing a symmetry axis of one of the conductive loops is in parallel with a plane containing a symmetry axis of the other conductive loop. With the arrangement like this, it is possible to transfer magnetic energy, in particular, magnetic energy contributing to the differential transmission with efficiency.

Further, in the example shown in FIGS. 3A and 3B, the two conductive loops (i.e., the coupling elements 23 and 33) have identical shapes. By adopting the identical shape, when each of the communication devices 2 and 3 has a transmitter and a receiver, a transmitter and a receiver having the same characteristics can be used for the communication devices 2 and 3. Therefore, there is an advantage that a common device configuration can be used. In contrast to this, when the two couplers (i.e., the two conductive loops) have different shapes, the loads on the couplers are different from each other. Therefore, the communication devices 2 and 3 need to be equipped with mutually different transmitters in order to drive the different couplers, and also be equipped with mutually different receivers for receiving signals having different amplitudes or different pulse waveforms. Therefore, when the two couplers (i.e., the two conductive loops) have different shapes, each of the communication devices 2 and 3 needs to be designed in a customized fashion.

Each of the coupling elements 23 and 33 shown in FIGS. 3A and 3B, which serves as an inductor, may be formed by a printed wiring on a wiring board, a lead frame inside a semiconductor package (i.e., an inner frame), or a wiring layer on a semiconductor substrate. The wiring board may be a rigid wiring board or a flexible wiring board. When each of the coupling elements 23 and 33 are formed by an inner frame inside a semiconductor package, each of the coupling elements 23 and 33 may be formed as shown in FIG. 4. FIG. 4 shows a configuration of a semiconductor package including a lead-frame coupler (i.e., a lead-frame inductor) that has been contrived by the present inventors. To show the lead frame shape inside the package, the illustration of a mold resin 70 is omitted. Further, the illustration of bonding wires that connect a semiconductor chip 78 mounted on a die pad 77 with leads 79 is also omitted. In the example shown in FIG. 4, a lead-frame coupler (i.e., a conductive loop) is formed by frame members 71 to 76, which are sealed inside the package by the mold resin 70. The frame members 71 and 76 at both ends of the lead-frame coupler are connected to the semiconductor chip 78 by bonding wires. The connection point of the bonding wire on the frame member 71 corresponds to one of the ports of the coupling element 23 (or the coupling element 33), i.e., the port P1A (or the port P2A), and the connection point of the bonding wire on the frame member 76 corresponds to the other port of the coupling element 23 (or the coupling element 33), i.e., the port P1B (or the port P2B). The semiconductor chip 78 includes at least one of a DMTX and a DMRX and at least one of a CMTX and a CMRX, and transmits or receives a differential-mode signal and a common-mode signal by using the lead-frame coupler formed by the frame members 71 to 76. By placing two semiconductor packages each having the configuration shown in FIG. 4 close together, non-contact coupling is formed between their lead-frame couplers, and thus making it possible to transmit a differential-mode signal and a common-mode signal between the two semiconductor packages.

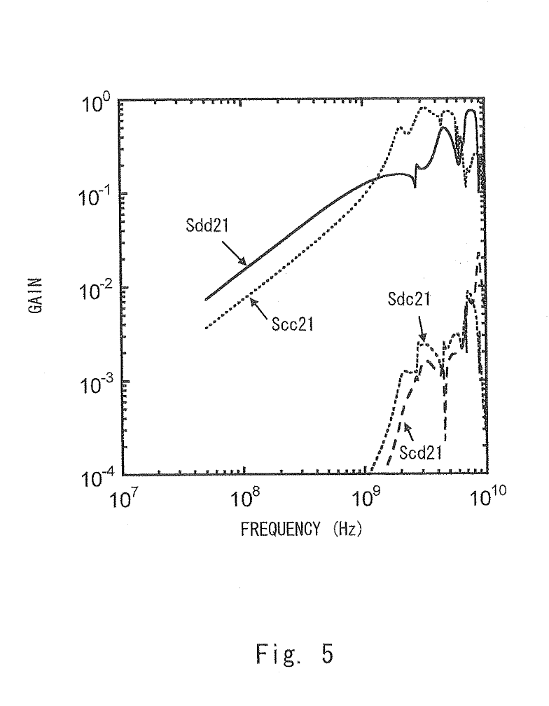

FIG. 5 is a graph showing an example of simulation results of a differential-mode gain (i.e., a transfer coefficient) Sdd21 and a common-mode gain (i.e., a transfer coefficient) Scc21 in a case where the coupling elements 23 and 33 are lead-frame couplers (i.e., lead-frame inductors) shown in FIG. 4. FIG. 5 shows the differential-mode gain (transfer coefficient) and the common-mode gain (transfer coefficient) by Mixed-mode S-parameters. The Sdd21 represents the transfer characteristic of a differential-mode signal from the mixed port P1 to the mixed port P2 of the coupler, for which the symbols are assigned in FIGS. 2 and 3. Further, the Scc21 represents the transfer characteristic of a common-mode signal from the mixed port P1 to the mixed port P2 of the coupler. More specifically, the Sdd21 represents the gain of a differential-mode signal that is applied to the mixed port P1 and transferred to the mixed port P2, and the Scc21 represents the gain of a common-mode signal that is applied to the mixed port P1 and transferred to the mixed port P2.

Based on simulation results including those shown in FIG. 5, the present inventors have found out that the differential-mode gain Sdd21 is relatively higher than the common-mode gain Scc21 over a wide band including a range near 0 Hz. The present inventors have also found out that, in contrast to this, the common-mode gain Sdd21 is insufficient over a wide band including a range near 0 Hz, though the common-mode gain Sdd21 exhibits high values in a part of a high frequency band (roughly 2 to 5 GHz in FIG. 5).

FIG. 5 also shows a simulation result of Sdc21 and Scd21 that represent mode conversion amounts between the differential-mode and the common-mode. As obvious from these results, since the lead-frame couplers have symmetric shapes with each other and are arranged to face each other, the gains of the Scd21 and Sdc21 corresponding to the mode conversion are sufficiently small to be negligible. It can be seen that when the coupling elements 23 and 33 are lead-frame couplers (i.e., lead-frame inductors) shown in FIG. 4, the gains of the Scd21 (i.e., influence to a differential-mode signal when a common-mode signal is applied) and the Sdc21 (i.e., influence to a common-mode signal when a differential-mode signal is applied) are sufficiently small to be negligible.

Based on these findings, the present inventors has contrived, as a preferable aspect, an aspect in which a baseband signal (i.e., a pulse wave signal) such as an NRZ signal is transmitted as a differential-mode signal and a modulated carrier wave signal is transmitted as a common-mode signal. In other words, baseband transmission is performed in a differential-mode, and carrier-band transmission (or pass-band transmission) is performed in a common-mode. The modulation is typically a sine-wave modulation using a sine wave as a carrier wave. Examples of the modulation technique include on off keying (OOK), amplitude shift keying (ASK), frequency shift keying (FSK), phase shift keying (PSK), and quadrature amplitude modulation (QAM). Examples of the line coding applied to the baseband signal include dipolar NRZ coding, dipolar RZ coding, bipolar (alternative mark inversion (AMI)) NRZ coding, bipolar RZ coding, and bi-phase coding. Further, in differential-mode transmission through inductive coupling, changes in current on the transmitting side mainly contribute to the signal transfer. Therefore, the DMTX may generate, as the transmission baseband signal, a differential voltage signal (e.g., bipolar pulse signal or Manchester code signal) for obtaining a desired current pulse waveform (e.g., Gaussian pulse waveform). The spectrum of the baseband signal includes frequency components near 0 Hz. In contrast to this, in the spectrum of a modulated carrier wave signal, the center frequency shifts to the frequency of the carrier wave. Therefore, by setting the frequency of the carrier wave in a frequency range in which the common-mode gain is high, it is possible to perform common-mode transmission between the coupling elements 23 and 33, which serve as inductors, in an effective manner.

Further, in carrier wave transmission in a common-mode, it is desirable to limit the band of the baseband signal used for the modulation of the carrier wave by using an appropriate low-pass filter (e.g., Nyquist filter, a cosine roll-off filter, or a raised cosine filter). In this way, the occupied band of the sine-wave-modulated carrier wave signal is limited to about twice the symbol rate at the maximum. Therefore, it is possible to effectively use the frequency range in which the common-mode gain is high. Further, in order to conform to laws and regulations relating to the radiation power of wireless devices in each country, the above-described frequency band of the carrier wave should desirably be set, for example, in a band called “Industrial, Scientific and Medical (ISM) band”. The ISM band includes, for example, a band from 2.4 GHz to 2.5 GHz.

As can be understood from the explanation using FIGS. 2 to 5, it is possible to simultaneously transmit a differential-mode signal and a common-mode signal through the non-contact coupling of the pair of coupling elements 23 and 33, each of which is an inductor, by simultaneously driving the coupling elements 23 and 33 by the differential-mode signal and the common-mode signal. Further, in a preferable aspect, the common-mode signal is a modulated carrier wave signal. In this way, it is possible to effectively use the frequency range in which the common-mode gain is high for the common-mode transmission. The differential-mode signal may be an un-modulated baseband signal. In baseband transmission using no carrier wave, achieving a high bit-rate is usually easier in comparison to the carrier wave transmission. Therefore, as shown as signal waveforms A to D shown in FIG. 1, the bit-rate of data signal D1 that is transmitted by a differential-mode signal may be set to a higher value than that of data signal D2 that is transmitted by a common-mode signal.

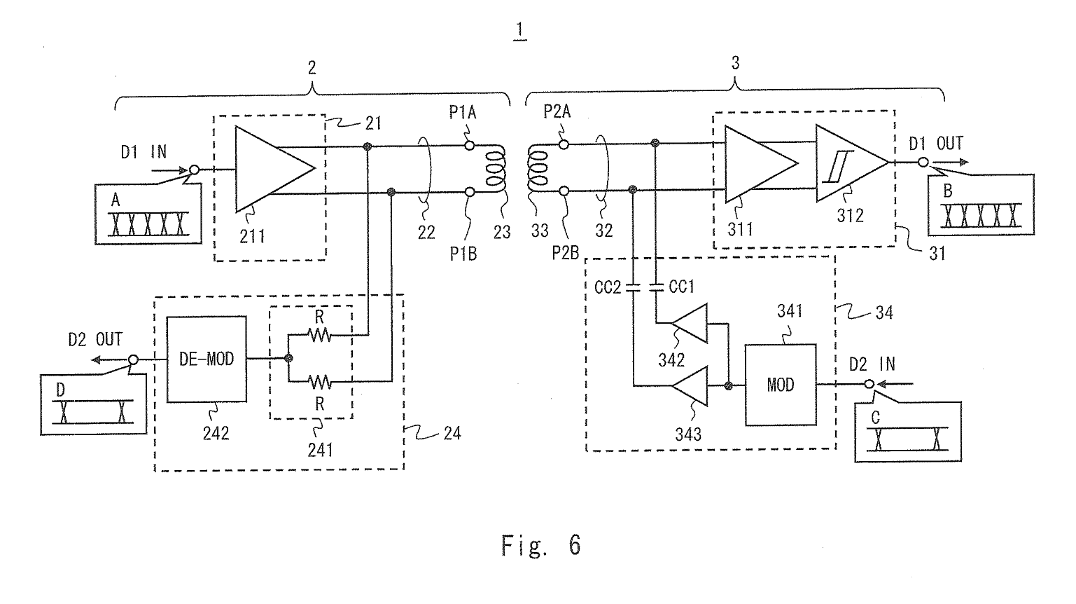

Next, specific configuration examples of the wireless communication system 1 performing carrier wave transmission in a common-mode and differential baseband transmission are explained hereinafter with reference to FIGS. 6 to 8. FIG. 6 shows a configuration example of the wireless communication system 1 that is illustrated in a more specific manner in comparison to FIG. 1. In the example shown in FIG. 6, the DMTX 21 includes a differential driver 211. The differential driver 211 receives data signal (i.e., a baseband signal) D1, generates a differential baseband signal, and then drives the coupling element 23 through the signal line pair 22. Since the simultaneous transmission of a differential-mode signal and a common-mode signal is assumed in this embodiment, it is desirable that common-mode noise caused by the differential driver 211 can be suppressed. Therefore, the last stage of the differential driver 211 may be configured as a cascode amplifier.

The DMRX 31 shown in FIG. 6 includes a differential amplifier 311 and a hysteresis comparator 312. The differential amplifier 311 receives a differential-mode signal received by the coupling element 33 and a common-mode signal that is superimposed in the signal line pair 32 by the CMTX 34. The differential amplifier 311 amplifies and outputs the differential-mode signal, while removes the common-mode signal. That is, the differential amplifier 311 can be regarded as a common-mode signal removal circuit. The hysteresis comparator 312 receives a differential baseband signal (i.e., a differential pulse signal) and outputs a comparison result between two signal voltages of the differential pulse signal. The output of the hysteresis comparator 312 indicates restored data signal D1.

The CMTX 34 includes a modulation circuit 341, single-end drivers 342 and 343, and an AC coupling capacitors CC1 and CC2. The modulation circuit 341 modulates a carrier wave by data signal D2 to be transmitted, and thereby generates a modulated carrier wave signal. The modulation circuit 341 performs a sine-wave modulation. The single-end drivers 342 and 343 supply the modulated carrier wave signal to two signal lines constituting the signal line pair 32 through the AC coupling capacitors CC1 and CC2. That is, the single-end drivers 342 and 343 supplies a common-mode signal to the signal line pair 32 and the coupling element 33. Each of the single-end drivers 342 and 343 may be, for example, a complementary metal-oxide semiconductor (CMOS) push-pull circuit.

The CMRX 24 shown in FIG. 6 includes a differential-mode signal removal circuit 241 and a demodulation circuit 242. The differential-mode signal removal circuit 241 receives a common-mode signal received by the coupling element 23 and a differential-mode signal that is superimposed in the signal line pair 22 by the DMTX 21, removes the differential-mode signal, and supplies the common-mode signal to the demodulation circuit 242. The removal of the differential-mode signal can be implemented by extracting the midpoint voltage between the two signal lines constituting the signal line pair 22. Specifically, as shown in FIG. 6, a resistor R may be connected in parallel with each of the two signal lines of the signal line pair 22, and the demodulation circuit 242 may be connected to the midpoint voltage point between these two resistors R. The demodulation circuit 242 performs demodulation processing for the received common-mode signal and thereby restores data signal D2.

Note that in FIG. 6, the illustration of the termination network is omitted. Termination elements may be disposed as appropriate at the output end of the DMTX 21, the input end of the DMRX 31, the output end of the CMTX 34, and the input end of the CMRX 24. For example, the last stage of the CMTX 34 may be configured as current mode logic (CML) and the load resistor of the CML may be used as a matching circuit for the common-mode signal. Alternatively, a termination resistor may be connected in parallel with each of the signal line pairs 22 and 23. Further, in FIG. 6, the illustration of the bias circuit is omitted. A bias circuit may be provided to supply a bias voltage to the CMRX 24 in preparation for the case where the CMRX 24 is driven while the DMTX 21 is in an off-state.

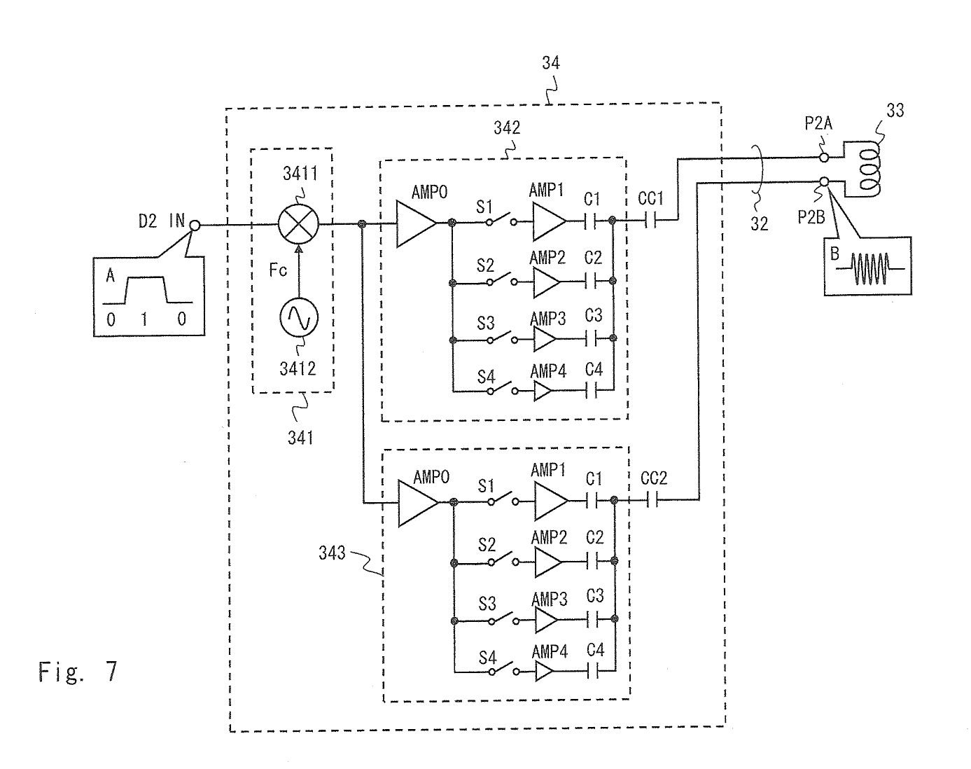

FIG. 7 is a block diagram showing a configuration example of the CMTX 34 shown in FIG. 6. The example shown in FIG. 7 shows an example in which a carrier wave is modulated by ASK or OOK. That is, the modulation circuit 341 includes a mixer 3411 and an oscillator 3412. The oscillator 3412 generates a carrier wave signal having a frequency Fc. The mixer 3411 mixes transmission data signal D2 with the carrier wave and thereby generated a modulated carrier wave signal. A signal waveform A shown in FIG. 7 represents a specific example of the signal waveform of the data signal D2. Although the illustration is omitted in FIG. 7, a band limiting filter (e.g., a cosine roll-off filter) for shaping the data signal (i.e., a baseband signal) D2 may be disposed in order to suppress inter-symbol interference in narrow-band common-mode transmission through the non-contact coupling between the coupling elements 23 and 33. The modulated carrier wave signal is supplied to the coupling element 33 through the single-end drivers 342 and 343. A signal waveform B shown in FIG. 7 represents a specific example of the signal waveform of the modulated carrier wave signal supplied to the coupling element 33.

The single-end drivers 342 and 343 shown in FIG. 7 are configured so that they can change the amplitude of the common-mode signal (i.e., a modulated carrier wave signal) supplied to the signal line pair 32 by changing the sizes of the driver and the capacitor. Specifically, each of the single-end drivers 342 and 343 shown in FIG. 7 has a two-stage configuration including an amplifier AMP0 and amplifiers AMP1 to AMP4. A plurality of amplifiers AMP1 to AMP4 and capacitors C1 to C4 are selectively used by the on/off operations of switches S1 to S4. It is possible to reduce the common-mode noise on the signal line pair 32 by reducing the amplitude of the common-mode signal to a necessary and sufficient level.

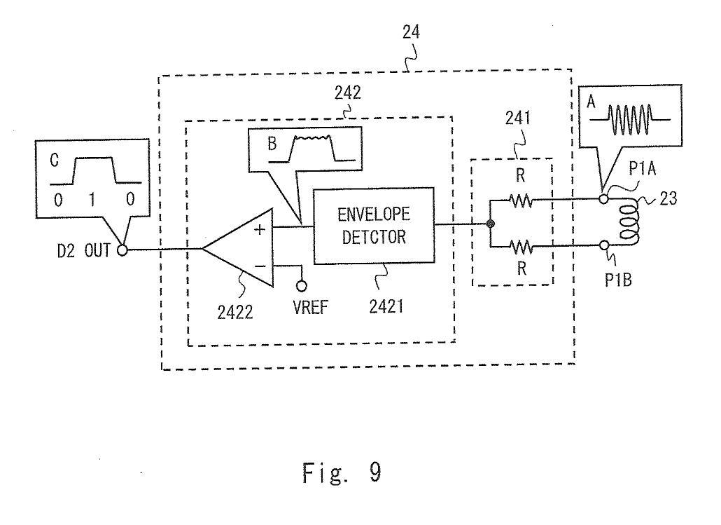

FIG. 9 is a block diagram showing a configuration example of the CMRX 24 shown in FIG. 6. The example shown in FIG. 9 demodulates a carrier wave that has been modulated by ASK or OOK and restores a reception symbols (i.e., reception data). More specifically, the demodulation circuit 242 includes an envelope detector 2421 and a comparator 2422. The envelope detector 2421 includes, for example, a rectification element and a low-pass filter, and outputs a signal (i.e., an envelope signal) that follows the envelope of a received common-mode signal. The comparator 2422 compares the envelope signal with a reference voltage VREF and outputs a comparison result representing data signal D2. Signal waveforms A to C shown in FIG. 9 represent specific examples of the signal waveforms of a received common-mode signal, an envelope signal output from the envelope detector 2421, and data signal D2 obtained by the comparator 2422 respectively.

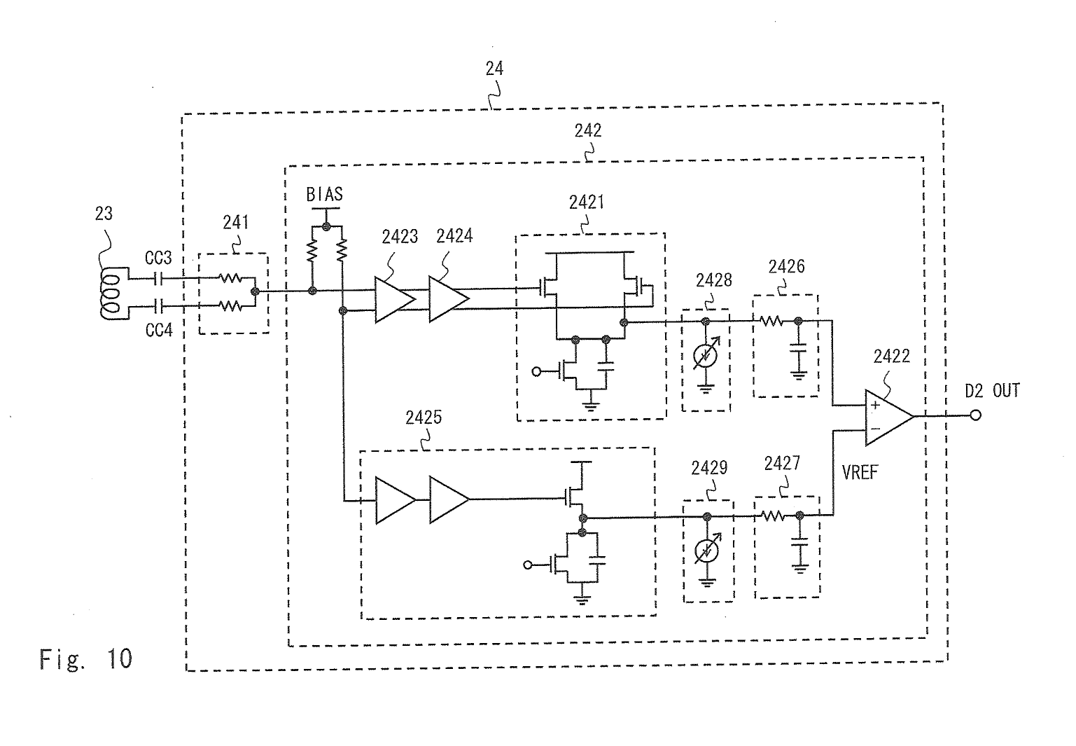

FIG. 10 is a circuit diagram showing a more detailed configuration example of the CMRX 24. In order to make it possible to set an arbitrary bias voltage in the CMRX 24, the CMRX 24 is connected to the coupling element 23 through AC coupling capacitors CC3 and CC4. In the configuration example shown in FIG. 10, differential amplifiers 2423 and 2424 receive and differentially amplify a single-end signal supplied from the differential-mode signal removal circuit 241 and an arbitrary bias voltage. Then, the envelope detector 2421 receives the differential signals generated by the differential amplifiers 2423 and 2424. The envelope detector 2421 shown in FIG. 10 includes a differential transistor pair and also includes a current source (illustrated, in FIG. 10, as a transistor to which an appropriate bias for operating it as a current source is provided) and a capacitor. The current source and the capacitor are connected in parallel between the sources of the differential transistor pair and a ground voltage. In this way, an envelope signal is output from the sources of the differential transistor pair. Further, in the configuration example shown in FIG. 10, a reference voltage VREF is generated by a replica path 2425. The outputs of the envelope detector 2421 and the replica path 2425 are supplied to the comparator 2422 through RC low-pass filters 2426 and 2427. Further, as shown in FIG. 10, the CMRX 24 may include variable current sources 2428 and 2429 as voltage level adjustment mechanisms. The variable current sources 2428 and 2429 are connected to the outputs of the envelope detector 2421 and the replica path 2425 in parallel.

As described above, the wireless communication system 1 according to this embodiment further drives the coupling elements 23 and 33, which are used for the transmission of the differential-mode signal by the inductive coupling, by the common-mode signal. In this way, the wireless communication system 1 can transmit the differential-mode signal and the common-mode signal simultaneously through the non-contact coupling of the pair of coupling elements 23 and 33. As a result, the wireless communication system 1 can perform unidirectional or bidirectional multiple-channel communication without requiring the use of a plurality of coupling element pairs and without requiring the resource division such as time-division multiplexing and frequency-division multiplexing.

Further, in a specific example of this embodiment, the differential-mode signal is an un-modulated baseband signal and the common-mode signal is a modulated carrier wave signal. In this way, it is possible to effectively use a frequency band in which the common-mode gain between the coupling elements 23 and 33 is high. Further, it is possible to achieve high bit-rate communication by performing differential baseband transmission. There is a possibility that the bit-rate of the common-mode transmission using a carrier wave is lower than that of the differential-mode transmission in which baseband transmission is performed. Therefore, the intended use of each of the common-mode transmission and the differential-mode transmission may be determined according to the difference in the bit-rate. For example, high bit-rate video signals may be transmitted by the differential-mode transmission and control signals may be transmitted by the common-mode transmission.

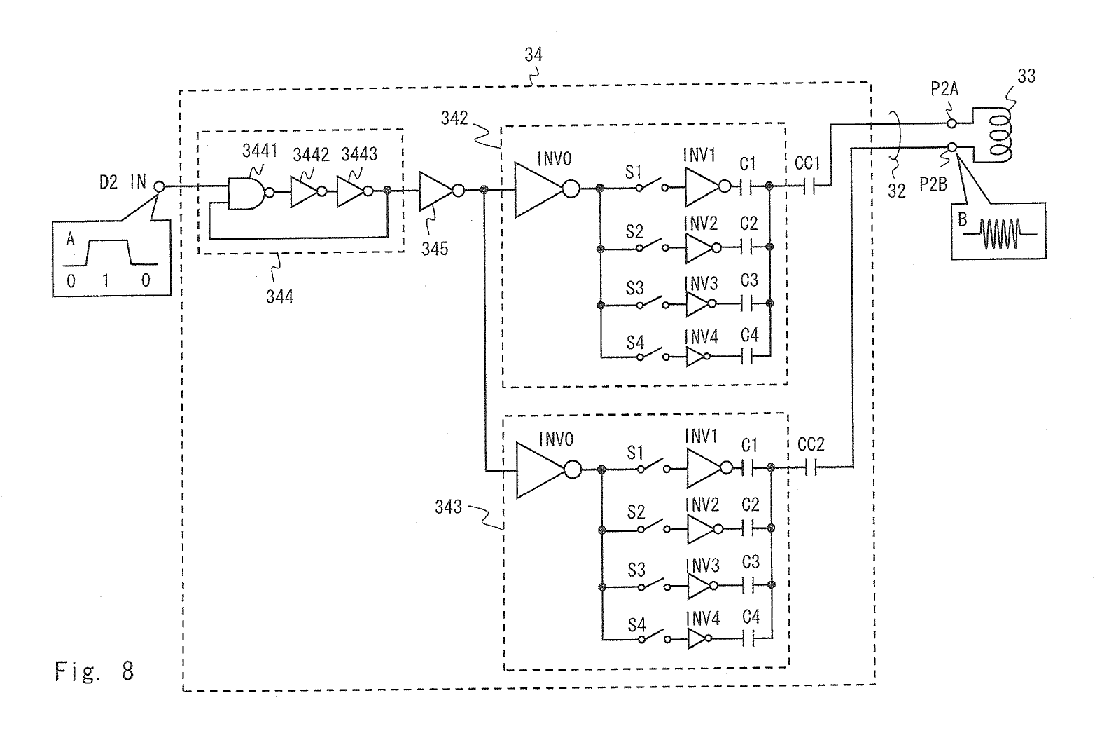

Examples using the sine-wave modulation are shown in the explanation made above. However, the modulation applied to the common-mode transmission may be a pulse modulation (or a rectangular-wave modulation) using a rectangular wave as a carrier wave. For example, amplitude of a pulse wave may be modulated by a data signal by using ASK or OOK. FIG. 8 is a block diagram showing a configuration example of the CMTX 34 that performs a pulse modulation by OOK. In FIG. 8, the modulation circuit 341 of the CMTX 34 shown in FIG. 7 is replaced by a ring oscillator 344 and an inverter 345.

The ring oscillator 344 includes one NAND circuit 3411 and two inverters (i.e., NOT circuits) 3442 and 3443. The ring oscillator 344 including the NAND circuit 3411 is operable to generate a pulse wave and to turn on/off the oscillation of the pulse wave according to a signal input to the NAND circuit 3411. By using data signal D2 (i.e., a modulating signal) as the input signal to the NAND circuit 3411, the ring oscillator 344 is operable to modulate the pulse signal by OOK. The use of ring oscillator 344 has an advantage that the circuit size can be reduced in comparison to the LC-VCO because the ring oscillator 344 needs no on-chip inductor element.

The inverter 345 inverts the output signal of the ring oscillator 344, and supplies the inverted signal to the single-end drivers 342 and 343. Each of the single-end drivers 342 and 343 shown in FIG. 8 has a two-stage configuration including an inverter INV0 and inverters INV1 to INV4. Similarly to the example shown in FIG. 7, a plurality of inverters INV1 to INV4 and capacitors C1 to C4 are selectively used by the on/off operations of switches S1 to S4. As a result, it is possible to reduce the amplitude of the common-mode signal to a necessary and sufficient level and thereby to reduce the common-mode noise on the signal line pair 32.

Even when an oscillator (e.g., the ring oscillator 344) generates a modulated pulse wave signal as in the example shown in FIG. 8, the common-mode signal waveform supplied to the coupling element 33 eventually has a waveform similar to a sine wave. This is because even when the coupling element 33 is driven by a pulse wave generated by the ring oscillator 344 or the like, the signal waveform is rounded (i.e., undergoes band limitation) due to ability of transistors and other factors such as loads including the signal line pair 32 and the coupling element 33. As a result, the waveform of the signal supplied to the coupling element 33 becomes a waveform that resembles to a sine wave rather than to a pulse wave. In other words, the sine wave signal that is transmitted as the common-mode signal may be a signal that was originally generated as a rectangular-wave signal by a pulse generation circuit such as a ring oscillator but has undergone band limitation.

Note that in the example shown in FIG. 8, the inverter 345 is provided so that the logic becomes consistent. Therefore, for example, the inverter 345 may be disposed inside the ring oscillator 344.

Further, although the examples shown in FIGS. 6 to 8 are explained by using configurations in which the AC coupling capacitors CC1 and CC2 are included in the CMTX 34, the capacitors CC1 and CC2 may be disposed in any places between the outputs of the single-end drivers 342 and 343 and the signal line pair 32.

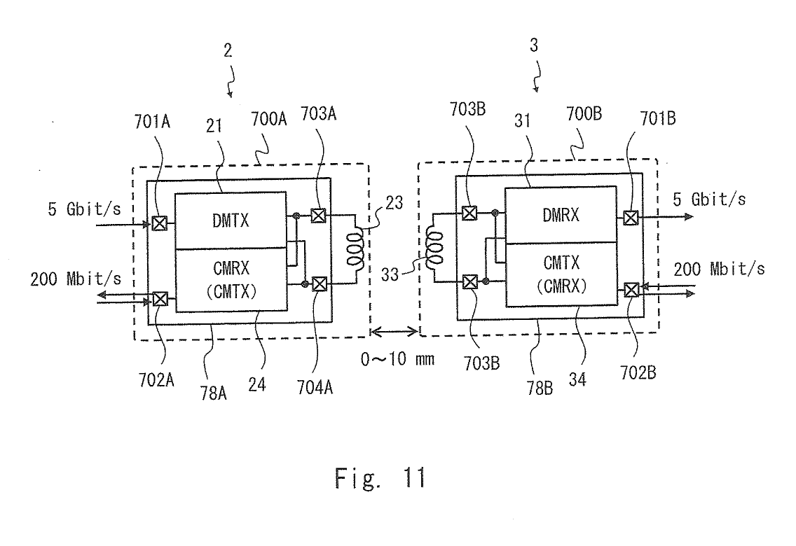

Next, several application examples of the wireless communication system 1 according to this embodiment are explained hereinafter. FIG. 11 shows an example in which the wireless communication system 1 is used for communication between semiconductor packages (i.e., between semiconductor chips). In the example shown in FIG. 11, the communication devices 2 and 3 are incorporated into semiconductor packages 700A and 700B respectively. The semiconductor packages 700A and 700B are disposed in close proximity of each other, for example, with an interval of about 0 to 10 mm therebetween. If the coupling elements 23 and 33 of the communication devices 2 and 3 are arranged so as not to short-circuit with each other, the semiconductor packages 700A and 700B may be in contact with each other (i.e., with an interval of 0 mm).

Firstly, a configuration of the communication device 2 is explained. The DMTX 21 and the CMRX (or CMTX) 24 are formed in a semiconductor chip 78A that is hermetically contained in the semiconductor package 700A. The semiconductor chip 78A includes a pad 701A for receiving data signal D1 and a pad 702A for transmitting or receiving data signal D2. Further, the semiconductor chip 78A includes pads 703A and 704A connected to the coupling element 23 serving as an inductor. Next, the communication device 3 is explained. The DMRX 31 and the CMTX (or CMRX) 34 are formed in a semiconductor chip 78B that is hermetically contained in the semiconductor package 700B. The semiconductor chip 78B includes a pad 701B for transmitting data signal D1 and a pad 702B for receiving or transmitting data signal D2. The semiconductor chip 78A also includes pads 703B and 704B connected to the coupling element 33 serving as an inductor.

In FIG. 11, the bit-rate of the data signal D2 is, for example, 200 Mbit/s and thus is lower than the bit-rate (e.g., 5 Gbit/s) of the data signal D1. The DMTX 21 and the DMRX 31 shown in FIG. 11 transmit/receive the data signal D1 having the bit-rate of 5 Gbit/s while maintaining the data signal D1 as the baseband signal. In contrast to this, the CMRX (CMTX) 24 and the CMTX (CMRX) 34 modulate a carrier wave by the data signal D2 having the bit-rate of 200 Gbit/s and transmit/receive the modulated carrier wave signal. The center frequency of the carrier wave signal may be set in a frequency range in which the common-mode gain between the coupling elements 23 and 33 is high. Note that according to the consideration by the present inventors, simulation results have shown that proper operations can be performed when the bit-rate of the data signal D2, which is transmitted as a common-mode signal, is less than about 500 Mbit/s. That is, the standards for USE (Universal Serial Bus) 2.0 and the like can be satisfied. Therefore, applications to those standards are possible.

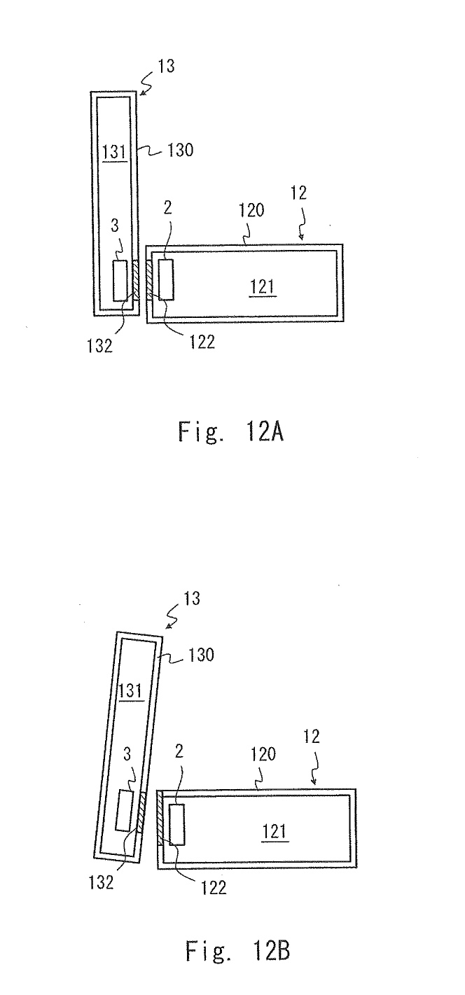

FIGS. 12A and 12B show examples in which the wireless communication system 1 is used for communication between electronic apparatuses. In FIGS. 12A and 12B, the communication device 2 is disposed in an electronic apparatus 12 and the communication device 3 is disposed in an electronic apparatus 13. The electronic apparatus 12 is, for example, an image transmission apparatus or an electronic control unit (ECU) for automotive control. The electronic apparatus 13 is, for example, an image display apparatus.

The communication device 2 is contained in a cavity 121 formed by a housing 120 of the electronic apparatus 12. Similarly, the communication device 3 is contained in a cavity 131 formed by a housing 130 of the electronic apparatus 13. At least part of each of the housings 120 and 130 is formed by a material transmissive to an electromagnetic wave for wireless communication between the communication devices 2 and 3, for example, by a dielectric material such as resin. In the examples shown in FIGS. 12A and 12B, windows 122 and 132 made of resin are disposed in parts of the housings 120 and 130 respectively. The parts other than the windows 122 and 132 of the housings 120 and 130 may be formed, for example, by metal material. By disposing the electronic apparatuses 12 and 13 in close proximity of each other, the communication devices 2 and 3 can perform wireless communication through non-contact coupling formed between the pair of coupling elements 23 and 33.

As shown in FIG. 12B, the electronic apparatus 13 may be configured so that its position or posture can be changed by a movable mechanism. For example, the electronic apparatus 13 may be configured to be able to incline in a similar manner to a display unit of a car navigation system. For example, when each of the coupling elements 23 and 33 is an inductor having a conductive loop as shown in FIGS. 3A and 3B, or FIG. 4, the communication devices 2 and 3 can obtain the highest communication quality when their conductive loops are arranged to face each other. However, when the position of the electronic apparatus 12 or 13 is changeable, there is a possibility that the communication quality varies depending on the positional relation between the electronic apparatuses 12 and 13. For example, the arrangement shown in FIG. 12D has a higher possibility that the communication quality could deteriorate than that for the arrangement shown in FIG. 12A. This is because when each of the coupling elements 23 and 33 is an inductor having a conductive loop, the surfaces of the two conductive loops are not in parallel with each other.

In order to prevent the deterioration in the communication quality in the arrangement shown in FIG. 12B, the size of at least one of the windows 122 and 132 is made larger. In this way, it is possible to prevent an electromagnetic wave from being blocked by the housing 120 or 130. Further, the electronic apparatuses 12 and 13 may be configured so that at least one of the communication devices 2 and 3 can be moved according to the change in the positional relation between the electronic apparatuses 12 and 13. For example, the electronic apparatuses 12 and 13 may be configured in such a manner that at least one of the communication devices 2 and 3 can be moved so that the communication devices 2 and 3 (i.e., the conductive loop surfaces of the coupling elements 23 and 33) become parallel with each other even in the arrangement shown in FIG. 12B.

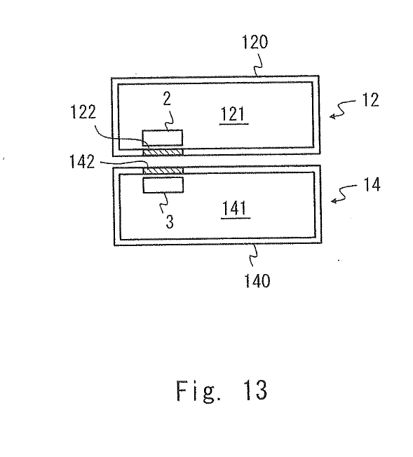

FIG. 13 shows another example in which the wireless communication system 1 is used for communication between electronic apparatuses. In FIG. 13, the communication device 2 is disposed in the electronic apparatus 12 and the communication device 3 is disposed in an electronic apparatus 14. Each of the electronic apparatuses 12 and 14 is, for example, an ECU for automotive control. In FIG. 13, the communication device 2 is contained in the cavity 121 formed by the housing 120 of the electronic apparatus 12 and the communication device 3 is contained in a cavity 141 formed by a housing 140 of the electronic apparatus 14. By disposing the electronic apparatuses 12 and 14 in close proximity of each other, the communication devices 2 and 3 face each other through windows 122 and 142. The windows 122 and 142 provided in the housings 120 and 140 are formed by dielectric material such as resin. In this manner, the communication devices 2 and 3 can perform wireless communication through non-contact coupling formed between the pair of coupling elements 23 and 33.

### Second Embodiment

In this embodiment, a modified example of the above-described first embodiment is explained. In the first embodiment, an example in which the common-mode signal is a modulated carrier wave signal is shown. In this embodiment, an example in which the differential-mode signal and the common-mode signal are transmitted in the same direction and the common-mode signal is an “un-modulated sine wave signal” is shown. This sine wave signal is used, for example, as a clock signal for specifying a bit-detection timing in a DMRX that receives the differential-mode signal.

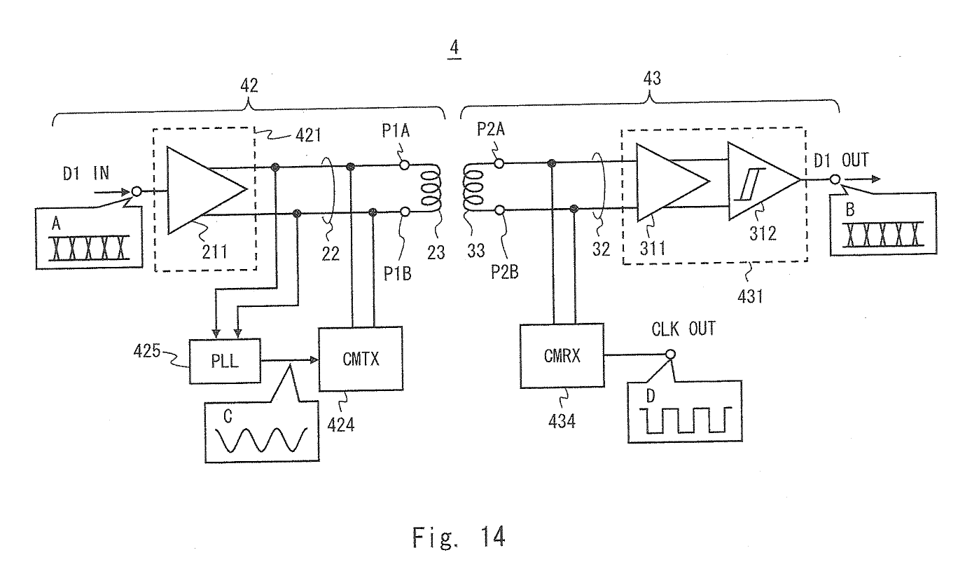

FIG. 14 is a block diagram showing a configuration example of a wireless communication system 4 according to this embodiment. In the example shown in FIG. 14, a communication device 42 transmits a differential-mode signal and a common-mode signal and a communication device 43 receives the differential-mode signal and the common-mode signal through non-contact coupling between coupling elements 23 and 33. The communication device 42 includes a signal line pair 22, a coupling element 23, a DMTX 421, a CMTX 424, and a phase locked loop (PLL) 425. The communication device 43 includes a signal line pair 32, a coupling element 33, a DMRX 431, and a CMRX 434. The signal line pair 22 is connected to ports P1A and P1B at both ends of the coupling element 23, and the signal line pair 32 is connected to ports P2A and P2B at both ends of the coupling element 33. The configurations and the operations of the DMTX 421 and the DMRX 431 may be similar to those of the DMTX 21 and the DMRX 31 shown in FIG. 1 or FIG. 6.

The PLL 425 adjusts the oscillating frequency and the phase of a voltage controlled oscillator (VCO) according to the edge timing of a transmission data signal D1 and thereby generates a sine-wave clock signal that follows the frequency and the phase of the transmission data signal D1. A signal waveform C shown in FIG. 14 represents a specific example of the sine-wave clock signal. The frequency of the sine-wave clock signal generated by the PLL 425 may be substantially equal to the fundamental frequency of the data signal D1 (for example, signal waveforms A and B shown in FIG. 14). When the data signal D1 is an NRZ signal, the fundamental frequency of the data signal D1 is half the bit-rate Rb of the data signal D1 (i.e., Rb/2 [Hz]). On the other hand, the frequency of the sine-wave clock signal may be a frequency that is obtained by multiplying or dividing the fundamental frequency of the data signal D1. In such a case, the frequency of the sine-wave clock signal is preferably selected within a frequency band in which the common-mode gain between the coupling elements 23 and 33 is high. By doing so, it is possible to prevent the degradation of the sine-wave clock signal due to the common-mode transmission.

The CMTX 424 drives the two signal lines of the signal line pair 22 by the sine-wave clock signal generated by the PLL 425. That is, the CMTX 424 uses the sine-wave clock signal as a common-mode signal. The CMTX 424 does not necessarily have to have the modulation function. The CMRX 434 receives the common-mode signal through the coupling element 33 and the signal line pair 32 and restores the clock signal. Note that as shown in FIG. 14, the CMRX 434 may restore a rectangular-wave clock signal rather than the sine-wave clock signal. This is because the rectangular-wave clock signal is suitable for the operation of a synchronized digital circuit (e.g., a D-latch and a register). A signal waveform D shown in FIG. 14 represents a specific example of the rectangular-wave clock signal restored by the CMRX 434. Further, the CMRX 434 may multiply or divide the frequency of the restored clock signal as necessary.

FIG. 15 is a block diagram showing another configuration example of a wireless communication system 4 according to this embodiment. In the another configuration example of the wireless communication system 4 shown in FIG. 15, the PLL 425 disposed in the wireless communication system 4 shown in FIG. 14 is replaced by an oscillator 426. Further, in the example shown in FIG. 15, a phase interpolator (PI) 435 for following the frequency and the phase of a differential-mode signal is disposed on the receiving side. The configurations and operations of the other elements shown in FIG. 15 may be similar to those of the elements denoted by the same symbols in FIG. 14.

The oscillator 426 generates a sine wave signal. A signal waveform C shown in FIG. 15 represents a specific example of the sine wave signal generated by the oscillator 426. As understood from the previous explanation about FIG. 14, the frequency of a sine wave signal generated by the oscillator 426 may be substantially equal to that of the fundamental frequency of the data signal D1 (e.g., signal waveforms A and B shown in FIG. 15) or may be different from the fundamental frequency of the data signal D1. The CMTX 424 drives the two signal lines of the signal line pair 22 by the sine-wave clock signal generated by the oscillator 426. The CMRX 434 receives the common-mode signal and restores the sine-wave clock signal or the rectangular-wave clock signal. The PI 435 generates multi-phase clock signals from the clock signal restored by the CMRX 434 and selects an optimal clock phase based on the edge timing of the received differential-mode signal (pulse voltage change). A signal waveform D shown in FIG. 15 represents a specific example of a rectangular-wave clock signal output from the PI 435.

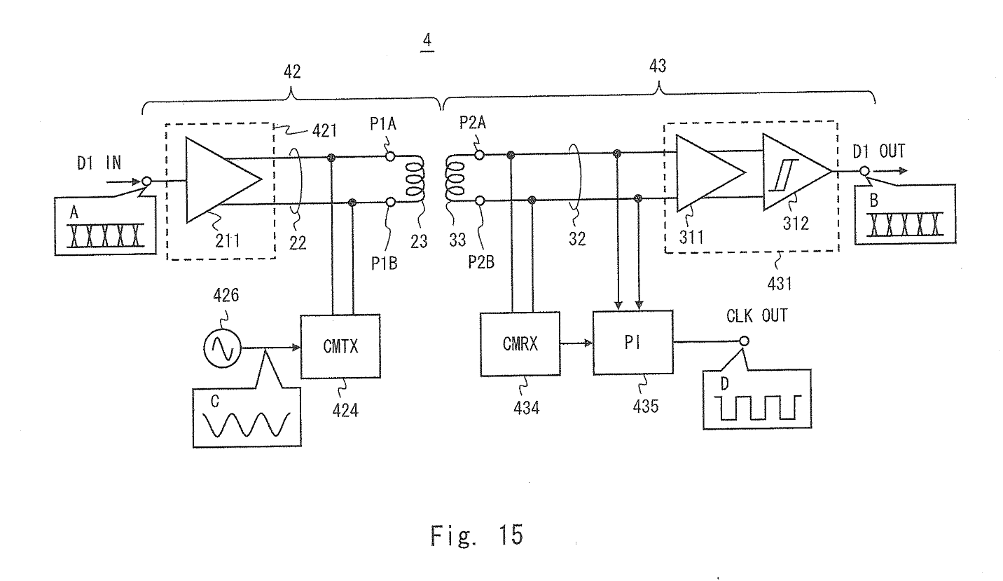

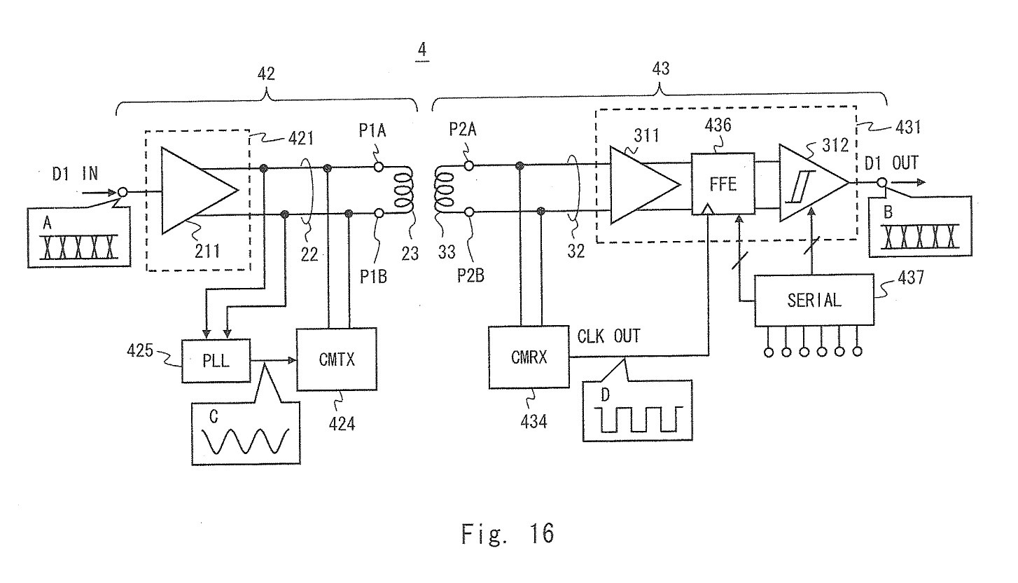

FIGS. 16 and 17 are block diagrams showing other configuration examples of the wireless communication system 4 according to this embodiment. FIGS. 16 and 17 show specific examples of uses of a clock signal received by the CMRX 434. As obvious from the comparison between FIGS. 16 and 14, the configuration example shown in FIG. 16 is different from that shown in FIG. 14 in that the clock signal restored by the CMRX 434 is supplied to a feed forward equalizer (FFE) 436 disposed in the DMRX 431. The configurations and operations of the elements other than the FFE 436 shown in FIG. 16 may be similar to those of the elements denoted by the same symbols in FIG. 14. The FFE 436 is a finite impulse response (FIR) filter including delay elements and shapes the waveform of the received differential-mode signal. The clock signal is for example used for the operation of a delay element and the like disposed inside the FFE 436. The register 437 supplies tap coefficients to the FFE 436. The tap coefficients of the FFE 436 may be adaptively adjusted.

The example shown in FIG. 17 is different from that shown in FIG. 14 in that the clock signal restored by the CMRX 434 is supplied to a decision feedback equalizer (DFE) 438 disposed in the DMRX 431. The configurations and operations of the elements other than the DFE 438 shown in FIG. 17 may be similar to those of the elements denoted by the same symbols in FIG. 14. The DFE 438 includes an FIR filter for shaping the waveform of the received differential-mode signal, a sampling circuit that samples the shaped waveform, and an adjustment circuit that determines tap coefficients of the FIR filter. The clock signal is for example used for the operations of the RIF filter, the sampling circuit, and the like disposed in the DFE 438. The register 439 supplies tap coefficients to the DFE 438. The tap coefficients of the DFE 438 may be adaptively adjusted.

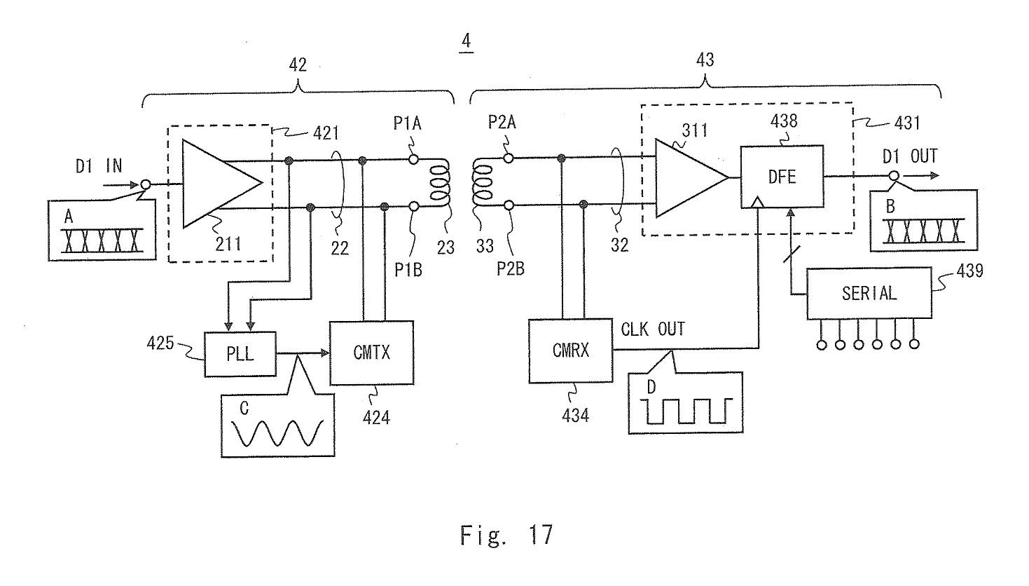

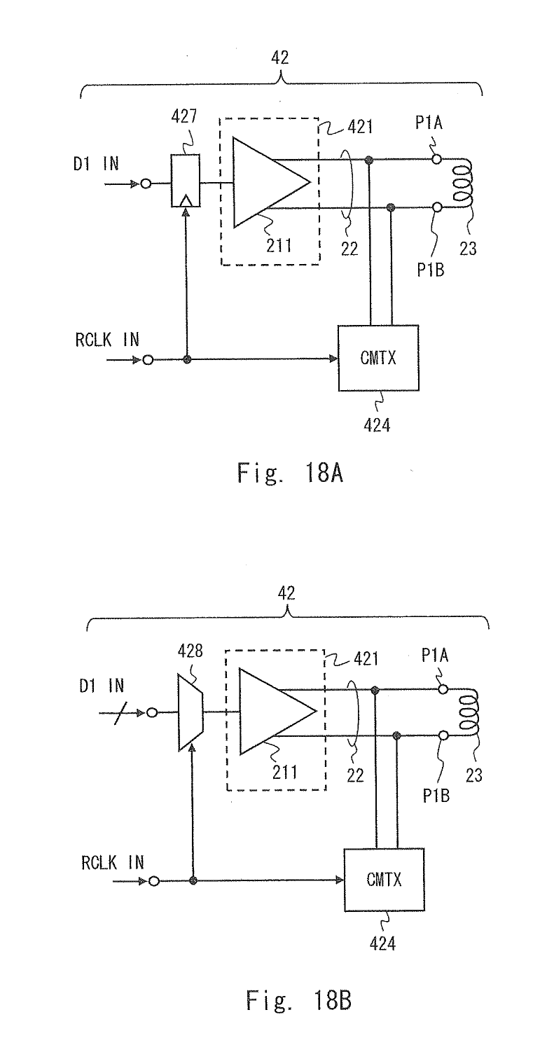

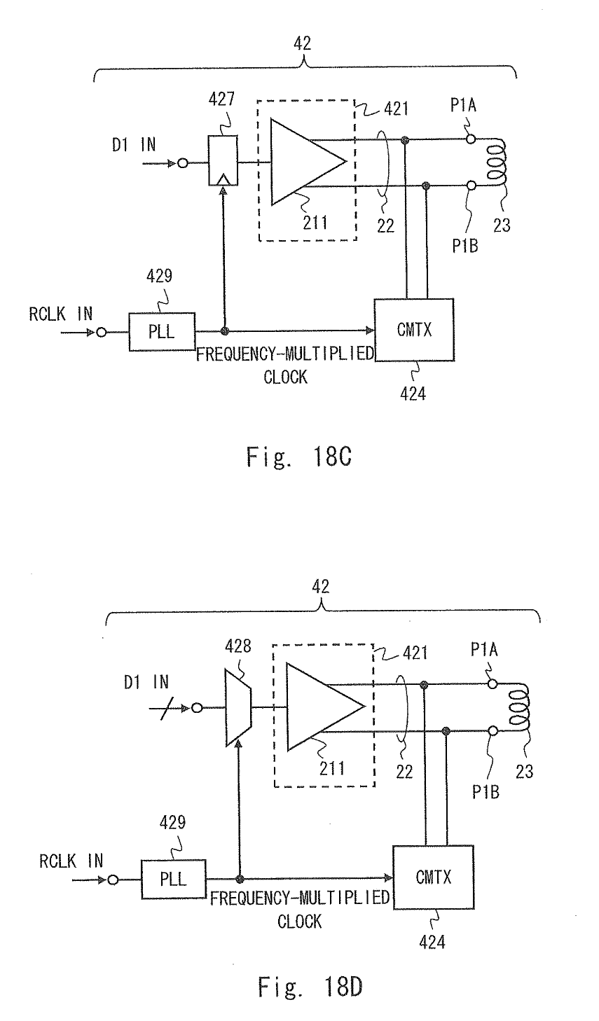

FIGS. 18A to 18D are block diagrams showing other configuration examples of the communication device 42 according to this embodiment. The configuration examples of the communication device 42 shown in FIGS. 18A to 18D are modified examples of the communication device 42 shown in FIGS. 15 to 17. The communication device 42 shown in FIGS. 15 to 17 reproduces the clock signal from the differential-mode signal (i.e., the data signal D1) in the PLL 425 and transmits the clock signal, which is synchronized with a differential-mode signal, from the CMTX 424 as the common-mode signal. In contrast to this, in the configuration examples shown in FIGS. 18A to 18D, the communication device 42 synchronizes the data signal D1 with an externally-supplied reference clock RCLK and transmits the reference clock RCLK and the data signal D1 which are synchronized with each other.

The configuration example shown in FIG. 18A does not include the PLL 425, which is included in the communication device 42 shown in FIGS. 15 to 17, but does include a flip-flop 427. In the example shown in FIG. 18A, the reference clock RCLK is supplied to the CMTX 424 and the flip-flop 427. The flip-flop 427 receives the data signal D1 and outputs the data signal D1 in synchronization with the reference clock RCLK. In this way, the data signal D1 is synchronized with the reference clock RCLK. The configurations and operations of the other elements shown in FIG. 18A may be similar to those of the elements denoted by the same symbols in FIG. 15, 16 or 17.

In the configuration example shown in FIG. 18B, the data signal D1 shown in FIG. 18A is changed from serial data to parallel data. To convert the parallel data into serial data, the configuration example shown in FIG. 18B includes a multiplexer 428 in place of the flip-flop 427. In the configuration example shown in FIG. 18B, the multiplexer 428 receives the reference clock RCLK and outputs the data signal D1 that has been serialized and synchronized with the reference clock RCLK. In this way, the serialized data signal D1 is synchronized with the reference clock RCLK. The configurations and operations of the other elements shown in FIG. 18B may be similar to those of the elements denoted by the same symbols in FIG. 15, 16 or 17.

FIG. 18C shows a modified example of the configuration example shown in FIG. 18A and includes a PLL 429 in addition to the configuration example shown in FIG. 18A. The PLL 429 receives the reference clock RCLK and generates a clock signal that is obtained by multiplying the frequency of the reference clock RCLK. The frequency-multiplied clock signal generated by the PLL 429 is supplied to the CMTX 424 and the flip-flop 427. As widely known, when a high-speed clock signal is to be generated in a semiconductor device, it is common to supply a low-speed clock signal to the semiconductor device and then generate a high-speed clock signal that is frequency-multiplied by a PLL disposed inside the semiconductor device. FIG. 18 C shows such a configuration.

FIG. 18D shows a modified example of the configuration example shown in FIG. 18B and includes a PLL 429 for generating a frequency-multiplied clock signal as in the case of FIG. 18C. The frequency-multiplied clock signal generated by the PLL 429 shown in FIG. 18D is supplied to the CMTX 424 and the multiplexer 428.

As described above, in the configuration examples shown in FIGS. 18A to 18D, the data signal D1 is synchronized with the reference clock RCLK or its frequency-multiplied clock. Therefore, a clock signal that is transmitted from the communication device 42 shown in FIGS. 18A to 18D as a common-mode signal can be used as a clock signal for the operation of the FFE 436 or DFE 438 as shown in FIGS. 16 and 17.

Similarly to the example described in the first embodiment in which the pulse modulation (rectangular-wave modulation) is used instead of the sine-wave modulation, in this embodiment, the clock signal does not have to be a precise sine wave signal. That is, the clock signal may be a signal that was originally generated as a rectangular-wave signal by a pulse generation circuit such as a ring oscillator but has undergone band limitation. In other words, the sine-wave clock signal that is transmitted as the common-mode signal may be a signal that was originally generated as a rectangular-wave clock signal by a pulse generation circuit such as a ring oscillator but has undergone band limitation.

### Third Embodiment

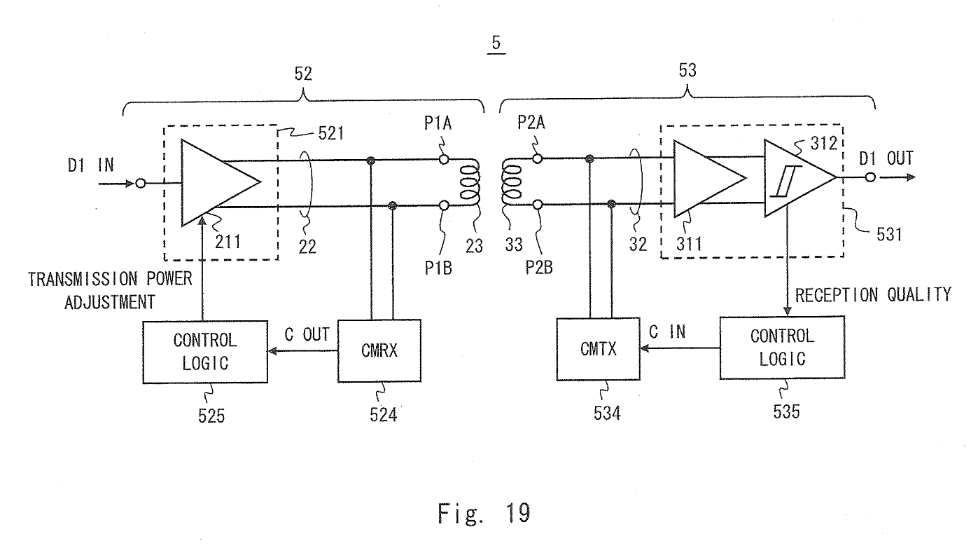

In this embodiment, a modified example of the above-described first embodiment is explained. Specifically, in this embodiment, a transmission power control sequence for a differential-mode signal using two-way communication of a differential-mode signal and a common-mode signal is explained. FIG. 19 is a block diagram showing a configuration example of a wireless communication system 5 according to this embodiment. In the example 19, a communication device 52 includes a signal line pair 22, a coupling element 23, a DMTX 521, a CMRX 524, and control logic 525. A communication device 53 includes a signal line pair 32, a coupling element 33, a DMRX 531, a CMTX 534, and control logic 535. The signal line pair 22 is connected to ports P1A and P1B at both ends of the coupling element 23, and the signal line pair 32 is connected to ports P2A and P2B at both ends of the coupling element 33. The configurations and the operations of the DMTX 521, the CMRX 524, the DMRX 531, and the CMTX 534 may be similar to those of the DMTX 21, the CMRX 24, the DMRX 31, and the CMTX 34 according to the first embodiment.

The communication device 53 is configured to transmit control data C used for the transmission power adjustment of a differential-mode signal in the communication device 52 by using a common-mode signal. Further, the communication device 52 is configured to adjust the transmission power of the differential-mode signal generated by the DMTX 521 according to the control data C transmitted from the communication device 53. For example, in consideration of the reduction in the power consumption, the communication devices 52 and 53 may perform control so that the transmission power of the differential-mode signal is reduced as much as possible. In consideration of the constant reception quality for the differential-mode signal, the communication devices 52 and 53 may perform control to increase/decrease the transmission power of the DMTX 521 so that reception level of the differential-mode signal at the DMRX 531 is kept in a predetermined range.

In the example shown in FIG. 19, control logic 525 and 535 are provided to adjust the transmission power of the DMTX 521. The control logic 535 disposed in the communication device 53 generates the control data C based on reception power level (e.g., reception amplitude) of the differential-mode signal at the DMRX 531 and transmits the control data C to the communication device 52 through the CMTX 534. The control logic 525 disposed in the communication device 52 receives the control data C from the communication device 53 through the CMRX 524 and adjusts the transmission power of the DMTX 521 based on the control data C. The control data C have only to include information that can be used as an index for the transmission power adjustment. The control data C may include, for example, control information indicating the transmission power of the DMTX 521 or measurement information indicating the reception power level of the DMRX 531. When the so-called inner-loop transmission power control is performed, the control data C may include control information indicating an increase request or a decrease request for the transmission power.

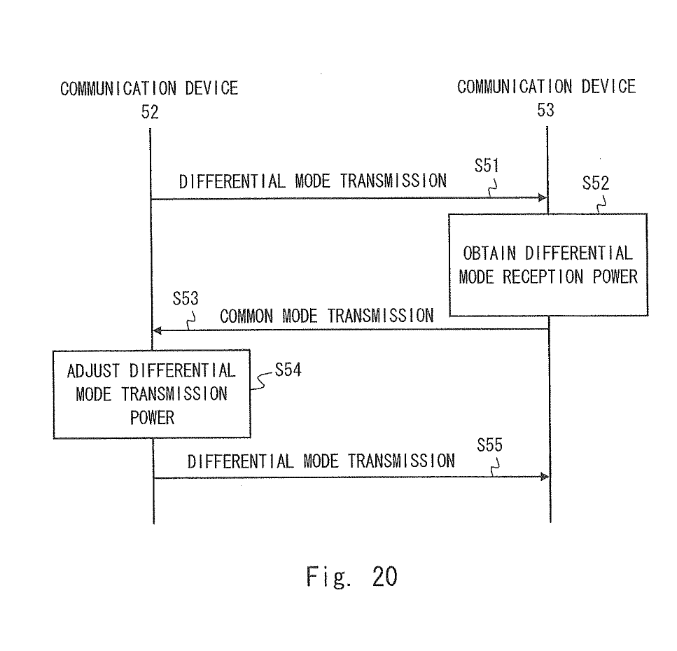

FIG. 20 shows an example of a transmission power control sequence according to this embodiment. In a step S51, the communication device 52 transmits the differential-mode signal. In a step S52, the communication device 53 obtains the reception power of the differential-mode signal received in the DMRX 531. In a step S53, the communication device 53 generates the control data C based on the reception power of the differential-mode signal and transmits the common-mode signal into which the control data C is encoded. In a step S54, the communication device 52 receives the common-mode signal from the communication device 53 and adjusts the transmission power of the differential-mode signal generated by the DMTX 521 according to the control data C. In a step S55, the communication device 52 transmits the differential-mode signal whose transmission power is adjusted.

As described above, the wireless communication system 5 according to this embodiment is operable to adjust the transmission power of the differential-mode signal generated by the DMTX 521 by using the fact that bidirectional transmission of the differential-mode signal and the common-mode signal is possible. As a result, it is possible to prevent the increase in the power consumption, the deterioration of the communication quality, the increase in the leakage electromagnetic field, or the like caused by excessive transmission power of the differential-mode signal.

Further, the use of the common-mode signal for controlling differential-mode transmission (e.g., transmission power adjustment) is also effective in terms of the difference between transmission distances of the common-mode signal and the differential-mode signal. As already described, it is believed that the differential-mode signal is transmitted mainly by inductive coupling (magnetic-field coupling) between the coupling elements 23 and 33. Since the inductive coupling (magnetic-field coupling) utilizes a spiral (rotational) magnetic field generated around a current flowing through the coupling element on the transmitting side, coupling strength of the inductive coupling (magnetic-field coupling) exponentially decreases with an increase in the distance from the coupling element on the transmitting side. Therefore, the maximum transmission distance of the differential-mode signal is very short. In contrast to this, it is believed that the common-mode signal is transmitted mainly by capacitive coupling (electric-field coupling) between the coupling elements 23 and 33. Since the capacitive coupling (electric-field coupling) utilizes an electric field that diverges from the charged coupling element on the transmitting side, its coupling strength decreases simply in proportion to the distance from the coupling element on the transmitting side. Therefore, by appropriately setting the specific forms and arrangements of the coupling elements 23 and 33 and the transmission power of each of the common-mode signal and the differential-mode signal, it is possible to make the maximum transmission distance of the common-mode signal longer in comparison to the maximum transmission distance of the differential-mode signal. Therefore, even when the distance between the coupling elements 23 and 33 is so large that the transmission of the differential-mode signal cannot be sufficiently performed, the communication devices 52 and 53 can control the differential-mode transmission by using the common-mode signal.

The communication device 53 (i.e., the control logic 535) may also adjust the transmission power of the CMTX 534 based on the reception power level of the differential-mode signal in the DMRX 531. By doing so, it is possible to prevent the increase in the power consumption, the deterioration of the communication quality, the increase in the leakage electromagnetic field, or the like caused by excessive transmission power of the common-mode signal.

The roles of the differential-mode signal and the common-mode signal explained in this embodiment may be interchanged. That is, the communication device 52 may feed back control data based on the reception power level of the common-mode signal at the CMRX 524 to the communication device 53 by using the differential-mode signal. Then, the communication device 53 may adjust the transmission power of the CMTX 534 according to the control data received in the DMRX 531.

### Fourth Embodiment

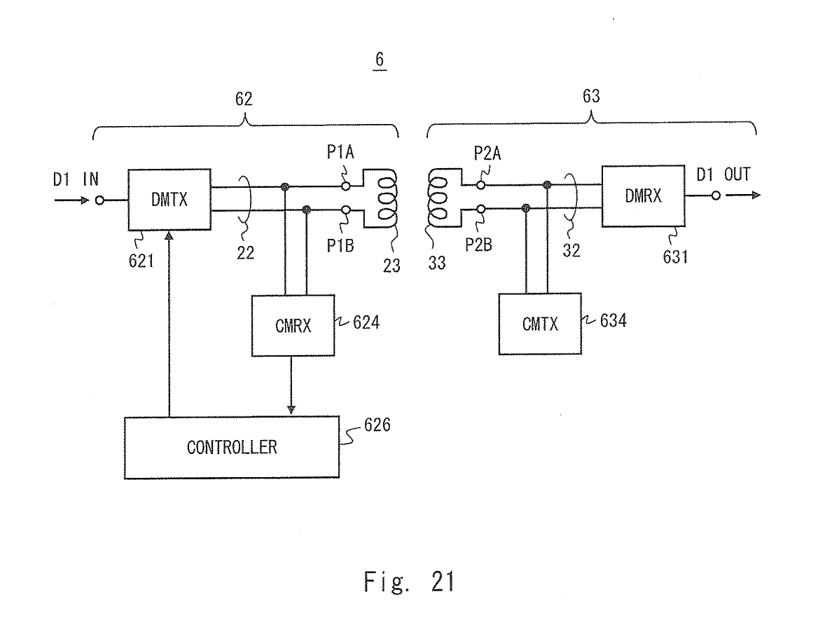

In this embodiment, a modified example of the above-described first or third embodiment is explained. Specifically, this embodiment describes an example in which common-mode transmission is used for detecting the presence of a corresponding device to be communicated and waking up the DMRX or the DMTX in response to the detection. FIG. 21 is a block diagram showing a configuration example of a wireless communication system 6 according to this embodiment. In the example shown in FIG. 21, a communication device 62 includes a signal line pair 22, a coupling element 23, a DMTX 621, a CMRX 624, and control logic 626. Further, a communication device 63 includes a signal line pair 32, a coupling element 33, a DMRX 631, and a CMTX 634. The signal line pair 22 is connected to ports P1A and P1B at both ends of the coupling element 23, and the signal line pair 32 is connected to ports P2A and P2B at both ends of the coupling element 33. The configurations and the operations of the DMTX 621, the CMRX 624, the DMRX 631, and the CMTX 634 may be similar to those of the DMTX 21, the CMRX 24, the DMRX 31, and the CMTX 34 according to the first embodiment.

The communication device 62 is configured to wake up the DMTX 621 for differential-mode signal transmission in response to successful reception of the common-mode signal from the communication device 63. The control logic 626 wakes the DMTX 621 up in response to reception of a common-mode signal by the CMRX 624.

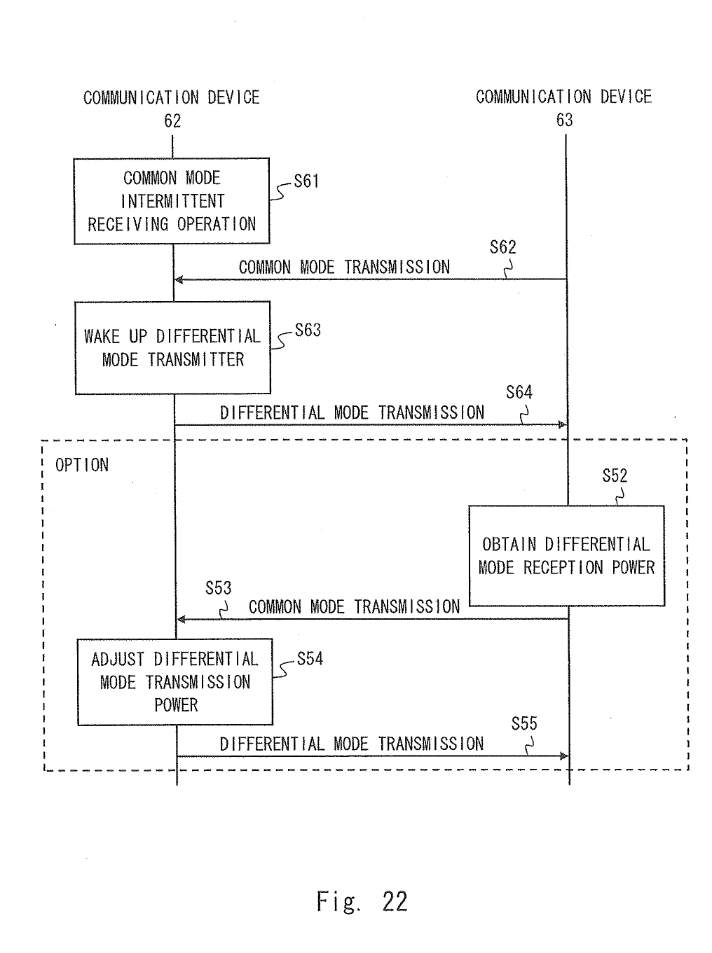

FIG. 22 shows an example of a wake-up sequence of the DMTX 621 according to this embodiment. Ina step S61, the communication device 62 suspends the operation of the DMTX 621 (e.g., stops the power supply to the DMTX 621) and operates the CMRX 624 continuously or intermittently. In a step S62, the communication device 62 receives the common-mode signal transmitted from the communication device 63 in the CMRX 624. In a step S63, in response to reception of the common-mode signal, the communication device 62 supplies electric power to the DMTX 621 and thereby starts the operation of the DMTX 621. In a step S64, the communication device 62 transmits the differential-mode signal from the DMTX 621.

As shown in FIG. 22, the transmission power of the differential-mode signal may be adjusted through a similar procedure to that explained in the third embodiment (FIG. 20) after the wake-up of the DMTX 621. Note that steps S52 to S55 in FIG. 22 are just an option of this embodiment. Further, in this embodiment, the communication devices 62 and 63 may adjust the transmission power of the common-mode signal after the wake-up of the DMTX 621.

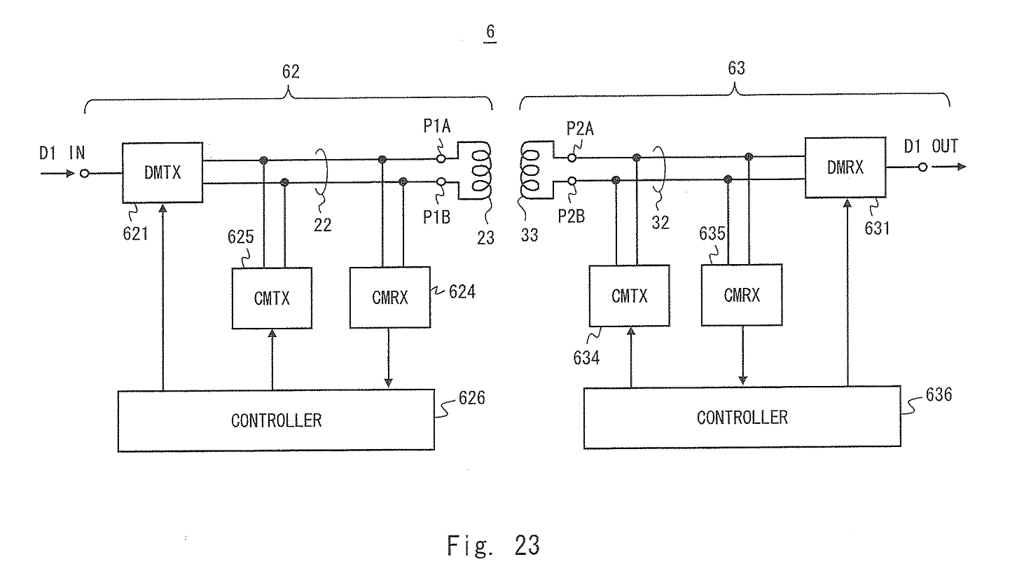

In the explanation made above, the wake-up of the DMTX 621 in the communication device 62 is explained. Similarly to this, the DMRX 631 in the communication device 63 may be woken up in response to successful reception of the common-mode signal. To that end, a controller 636 may be disposed in the communication device 63 as shown in FIG. 23. Further, to make it possible to transmit a common-mode signal from the communication device 62 to the communication device 63, a second CMTX 625 may be disposed in the communication device 62 and a second CMRX 635 may be disposed in the communication device 63. The controller 636 wakes the DMRX 631 up in response to reception of the common-mode signal by the second CMRX 635. The configurations and operations of the other elements shown in FIG. 23 may be similar to those of the elements denoted by the same symbols in FIG. 21.

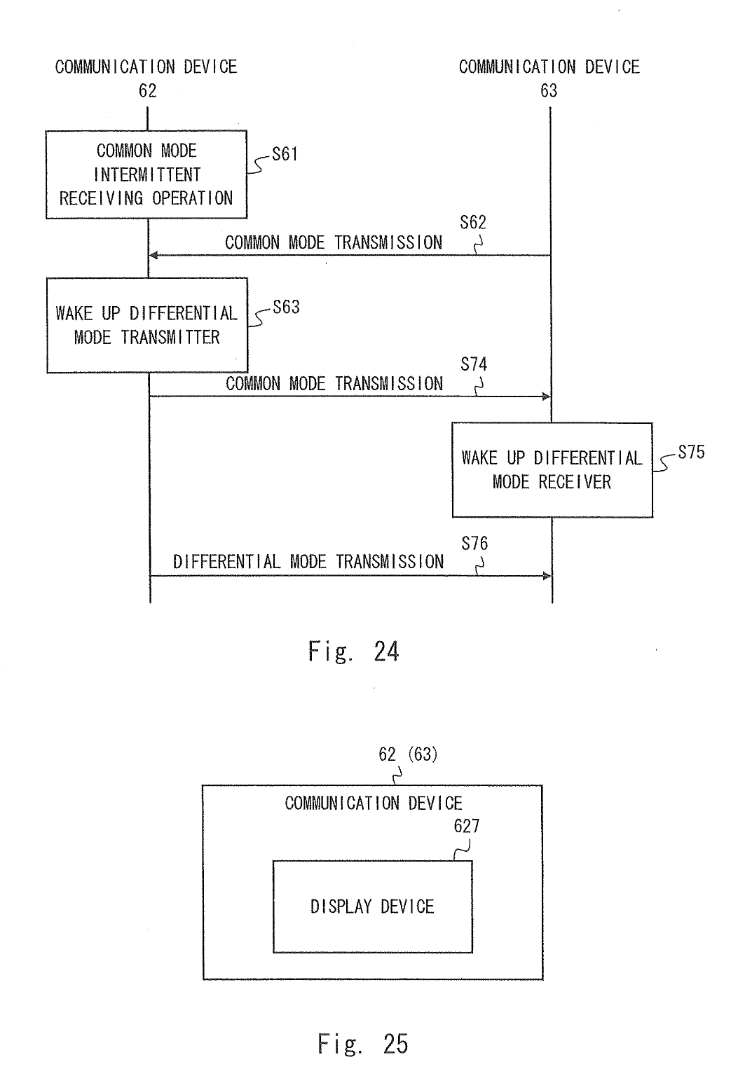

FIG. 24 shows an example of a sequence for waking up both the DMTX 621 and the DMRX 631 in response to successful transmission of the common-mode signal. The operations in steps S61 to S63 in FIG. 24 are similar to those in steps S61 to S63 in FIG. 22. In a step S74, the communication device 62 transmits the common-mode signal from the second CMTX 625. This common-mode signal serves as a trigger signal for urging the wake-up of the DMRX 631 in the communication device 63. In a step S75, the communication device 63 wakes the DMRX 631 up in response to reception of the common-mode signal in the second CMRX 635. In a step S76, the communication devices 62 and 63 transmit/receive the differential-mode signal by using the DMTX 621 and the DMRX 631.

According to this embodiment, the operation of the DMTX or the DMRX can be stopped until the transmission of the common-mode signal succeeds. Therefore, the power consumption for the operation of the DMTX or the DMRX can be reduced. Further, as described above in the third embodiment, it is possible to make the maximum transmission distance of the common-mode signal larger in comparison to the maximum transmission distance of the differential-mode signal by appropriately setting specific forms and arrangements of the coupling elements 23 and 33 and the transmission power of each of the common-mode signal and the differential-mode signal. Therefore, by using a common-mode signal, it is possible to detect the presence of a corresponding device quickly and thereby to start up the DMTX or the DMRX. This is effective in applications in which arrangements of the communication devices 62 and 63 and/or a distance between the communication devices change. For example, it is conceivable that the wireless communication system 6 is applied to communication between portable equipment and a cradle, communication between portable equipment and a store-front station (e.g., kiosk terminal), and so on. According to this embodiment, the DMTX or the DMRX for differential-mode transmission is woken up in response to successful common-mode transmission between the communication devices 62 and 63 as the communication devices 62 and 63 spatially come closer little by little. Therefore, according to this embodiment, when the communication devices 62 and 63 come closer even further to a distance at which they can perform differential-mode transmission, the communication devices 62 and 63 can start differential-mode transmission without any delay.

Further, in this embodiment, at least one of the communication devices 62 and 63 may display information about whether communication on the differential-mode signal is possible or not. For example, when the reception quality of the differential-mode signal is insufficient (e.g., when the reception quality is lower than a predetermined threshold), in other words, when the reception quality of the differential-mode signal is presumed to be insufficient based on the reception quality of the common-mode signal, at least one of the communication devices 62 and 63 may display information for urging the user to adjust the arrangement of the communication device. Further, after the transmission/reception of the differential-mode signal is started, at least one of the communication devices 62 and 63 may display information for urging the user to adjust the arrangement of the communication device in response to detection that the reception quality of the differential-mode signal is insufficient (e.g., the reception quality is lower than a predetermined threshold). The communication device 63 may transmit a notice indicating that the reception quality of the differential-mode signal is insufficient to the communication device 62 by using the common-mode signal. The displayed information may include an image or text for urging the user to move one of the communication devices (e.g., portable equipment) closer to the other communication device (e.g., a cradle or a store-front station). Further, to display that information, at least one of the communication devices 62 and 63 may include a display device 627 as shown in FIG. 25. Examples of the display device 627 include a liquid crystal display device, an organic electroluminescence display device, and a display device using light-emitting elements such as light emitting diodes (LEDs).

### Fifth Embodiment

Regarding a communication in which a baseband signal is transmitted in differential-mode and a modulated carrier wave signal is transmitted in common-mode, this embodiment describes a relation between the bit-rate Rb (or the fundamental frequency) of a baseband signal transmitted in differential-mode and a frequency of a carrier wave signal transmitted in common-mode. Note that in the case of an NRZ signal, the fundamental frequency of the baseband signal is half the bit-rate Rb (i.e., Rb/2 [Hz]).

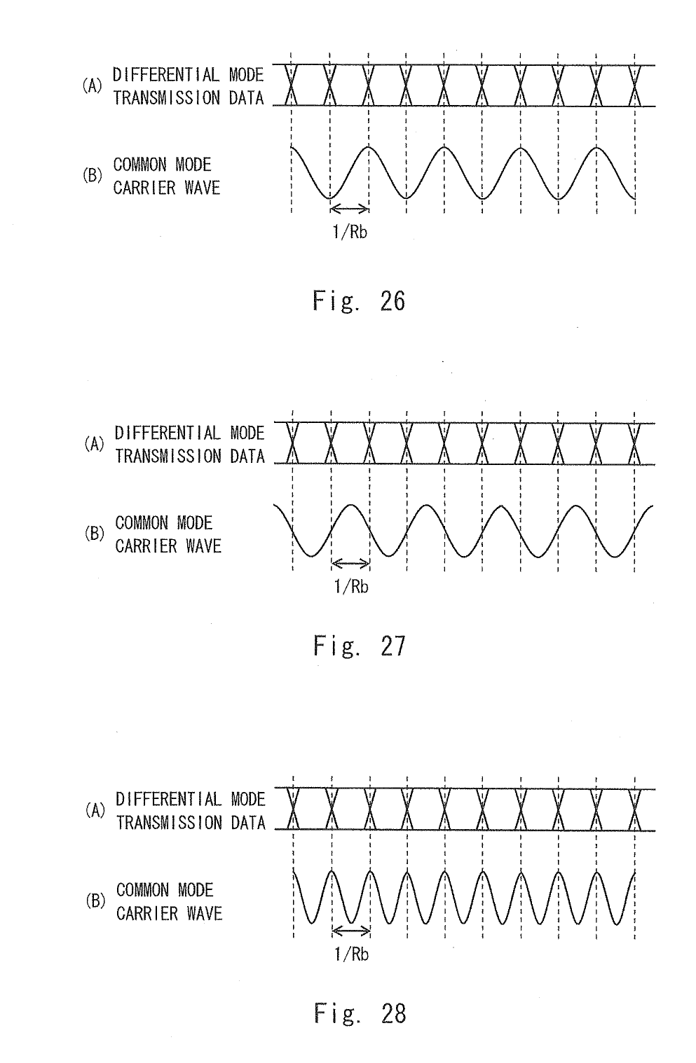

FIG. 26 shows one of preferable relations between the bit-rate Rb (or the fundamental frequency) of the baseband signal in differential-mode and the carrier wave frequency in common-mode. In the example shown in FIG. 26, the carrier wave frequency in common-mode is half the bit-rate Rb (i.e., Rb/2 [Hz]) of the baseband signal in differential-mode. If the carrier wave frequency in common-mode is an arbitrarily-determined frequency, jitter amount caused on the differential-mode signal by the common-mode signal fluctuates. In contrast to this, jitter amount caused on the differential-mode signal by the common-mode signal is substantially constant in the example shown in FIG. 26. Therefore, it is easy to ensure the communication quality of the differential-mode transmission.

Note that the carrier wave frequency in common-mode only has to be Rb/2 [Hz]. Therefore, the phase relation between the baseband signal and the carrier wave signal may be arbitrarily determined. For example, the phase relation between the baseband signal and the carrier wave signal may be set as shown in FIG. 27. In FIG. 26, the phase of the carrier wave in common-mode is shifted from the phase of the differential-mode baseband signal by 90 electrical degrees. In contrast to this, in FIG. 27, the phase of the carrier wave in common-mode conforms to the phase of the differential-mode baseband signal. However, the example shown in FIG. 26 is preferred as the phase relation between the baseband signal and the carrier wave signal. This is because when the common-mode signal changes widely at the edge position of the differential-mode signal, the noise that is caused by the common-mode signal and superimposed onto the differential-mode signal becomes larger and thereby could cause jitter on the differential-mode signal. To avoid this, it is preferable to align the point in the common-mode signal at which the variation is the smallest, i.e., the point at which the differential coefficient of the carrier wave in common-mode is the smallest, with the edge point of the differential-mode signal. In contrast to this, in FIG. 27, the edge position of the differential-mode signal is aligned with the edge position of the common-mode signal. In such a case, the jitter caused on the differential-mode signal by the common-mode signal increases in comparison to the example shown in FIG. 26. However, if the jitter amount is at such a level that the proper communication quality can still be ensured, the phase relation like the one shown in FIG. 27 may be also used. Even in such a case, since the phase relation between the differential-mode signal and the common-mode signal is known in advance, the designer can estimate the jitter amount on the differential-mode signal.

Further, the carrier wave frequency in common-mode may be an integral multiple of Rb/2 [Hz]. FIG. 28 shows a case where the carrier wave frequency in common-mode is Rb [Hz]. Even in this case, since the jitter amount caused on the differential-mode signal by the common-mode signal is unchanged, it is easy to ensure the communication quality of the differential-mode transmission.

### Sixth Embodiment

In this embodiment, a modified example of the above-described first or second embodiment is explained. Specifically, this embodiment describes an example in which common-mode transmission is used for electric power transmission. The DMRX rectifies a received common-mode signal and thereby extracts the received common-mode signal as electric power. The electric power extracted by the DMRX is supplied to a load (e.g., other circuit blocks or a rechargeable battery).

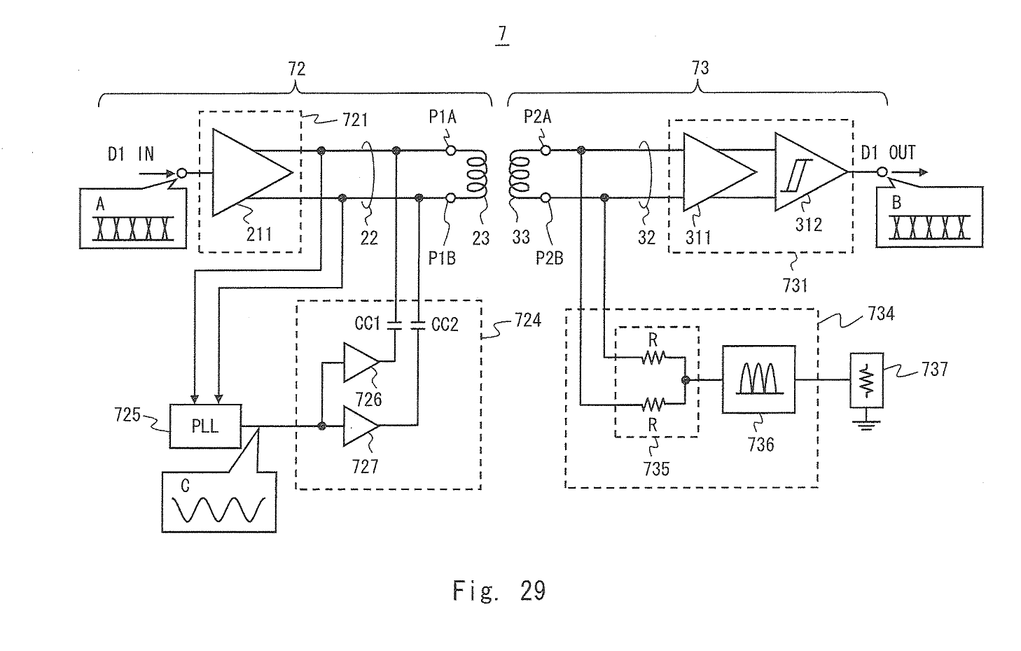

FIG. 29 is a block diagram showing a configuration example of a wireless communication system 7 according to this embodiment. In the example shown in FIG. 29, a communication device 72 transmits a differential-mode signal and a common-mode signal, and a communication device 73 receives the differential-mode signal and the common-mode signal through non-contact coupling between the coupling elements 23 and 33. The communication device 72 includes a signal line pair 22, a coupling element 23, a DMTX 721, a CMTX 724, and a PLL 725. Further, the communication device 73 includes a signal line pair 32, a coupling element 33, a DMRX 731, a CMRX 734, and a load 737. The signal line pair 22 is connected to ports P1A and P1B at both ends of the coupling element 23, and the signal line pair 32 is connected to ports P2A and P2B at both ends of the coupling element 33.

The configurations and the operations of the DMTX 721 and the DMRX 731 may be similar to those of the DMTX 21 and the DMRX 31 shown in FIG. 1 or FIG. 6. The configurations and the operations of the CMTX 724 and the PLL 725 may be similar to those of the CMTX 424 and the PLL 425 shown in FIG. 14. When the use is limited to power transfer, the CMTX 724 does not necessarily have to have the modulation function. The CMTX 724 may include, for example, single-end drivers 726 and 727, and AC coupling capacitors CC1 and CC2 as shown in FIG. 29. The single-end drivers 726 and 727 supply the output signal of the PLL 725 to two signal lines constituting the signal line pair 32 through the AC coupling capacitors CC1 and CC2.

The CMRX 734 shown in FIG. 29 includes a differential-mode signal removal circuit 735 and a rectifier 736. The differential-mode signal removal circuit 735 removes a differential-mode signal from a reception signal received by the coupling element 33 and supplies only a common-mode signal to the rectifier 736. Similarly to the differential-mode signal removal circuit 241 shown in FIG. 6, the differential-mode signal removal circuit 735 may be implemented by extracting the midpoint voltage between the two signal lines constituting the signal line pair 32. The rectifier 736 rectifies the common-mode signal and supplies the DC power to the load 737. The load 737 is, for example, other circuit blocks or a rechargeable battery.

A DC-DC converter (i.e., a voltage regulator) for converting the DC voltage into an appropriate voltage for the load 737 may be disposed between the rectifier 736 and the load 737, though its illustration is omitted in FIG. 29. Further, although a configuration example in which the common-mode signal and the differential-mode signal are transmitted in the same direction is shown in FIG. 29, the common-mode signal and the differential-mode signal may be transmitted in mutually-opposite directions.

Further, although a case where the common-mode signal, which is used as an electric-power signal, is a sine wave signal is shown in FIG. 29, the common-mode signal does not have to be a precise sine wave signal. For example, the common-mode signal may be a signal that was originally generated as a rectangular-wave signal by a pulse generation circuit such as a ring oscillator but has undergone band limitation.

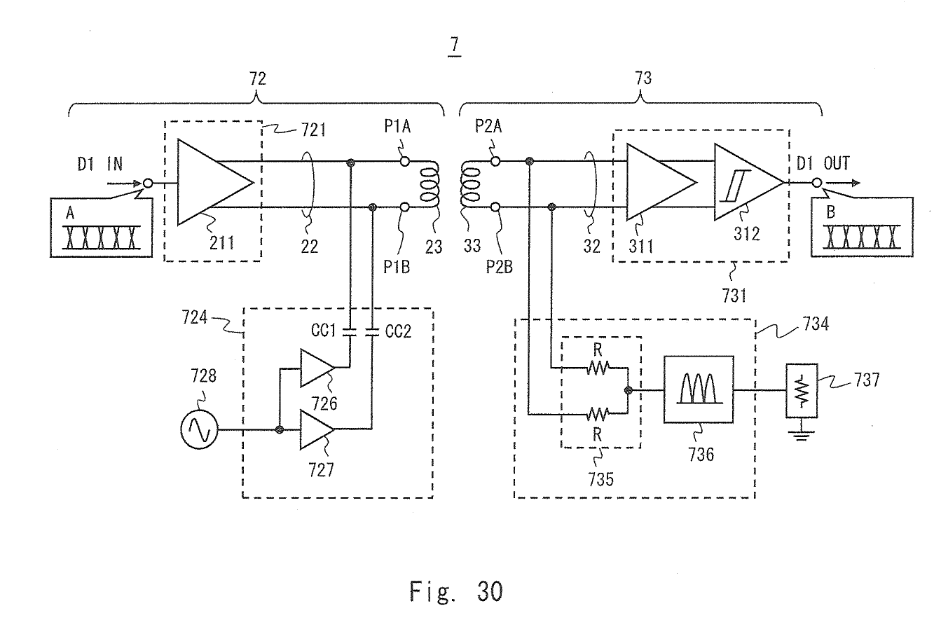

Further, the configuration shown in FIG. 29 includes the PLL 725. This is because the configuration used for clock signal transmission shown in FIG. 14 is used for electric power transmission. According to the configuration using the PLL 725 shown in FIG. 29, since the data signal D1 and the power signal can be easily synchronized, the jitter reduction effect described in the fifth embodiment can be achieved. However, the PLL 725 may be omitted because the synchronization between the data signal D1 and the power signal is not indispensable in electric power transmission. Therefore, the wireless communication system 7 according to this embodiment may be modified as shown in FIG. 30. In the example shown in FIG. 30, an oscillator 728 is provided in place of the PLL 725. A sine wave signal generated by the oscillator 728 is supplied to the signal line pair 22 through the CMTX 724 as the common-mode signal. Note that the output signal of the oscillator 728 does not have to be a precise sine wave signal. For example, the oscillator 728 may be a pulse generation circuit such as a ring oscillator. That is, the power signal supplied to the signal line pair 22 and the coupling element 23 may be a band-limited rectangular-wave signal, more specifically, a rectangular-wave signal whose bandwidth is limited in comparison to that of the data signal D1 (i.e., a baseband signal).

In this embodiment, the frequency of the common-mode signal, which is used as an alternating current signal, is preferably selected within a frequency band in which the common-mode gain between the coupling elements 23 and 33 is high. By doing so, it is possible to transmit the electric power of the common-mode signal with high efficiency.

### Other Embodiments

The above-described first to sixth embodiments may be combined as desirable.

While the invention has been described in terms of several embodiments, those skilled in the art will recognize that the invention can be practiced with various modifications within the spirit and scope of the appended claims and the invention is not limited to the examples described above. Further, the scope of the claims is not limited by the embodiments described above. Furthermore, it is noted that, Applicant's intent is to encompass equivalents of all claim elements, even if amended later during prosecution.

For example, the technical ideas obtained by the present inventors include Embodiments A1 to A46 shown below.

Embodiments A1, A2, A6 to A12, A17, A18, A22 to A28, A33 to A34, and A38 to A42 correspond, for example, to the above-described first embodiment.

Embodiments A3, A19 and A35 correspond, for example, to the above-described second embodiment.

Embodiments A14, A30 and A44 correspond, for example, to the above-described third embodiment.

Embodiments A13, A15, A29, A31, A43 and A45 correspond, for example, to the above-described fourth embodiment.

Embodiments A4, A5, A20, A21, A36 and A37 correspond, for example, to the above-described fifth embodiment.

Embodiments A16, A32 and A46 correspond, for example, to the above-described sixth embodiment.

### Embodiment A1

A wireless communication system including:

first and second communication devices;

a first coupling element connected to the first communication device through a first signal line pair; and

a second coupling element connected to the second communication device through a second signal line pair, wherein

the first and second communication devices are configured to wirelessly transmit, between the first and second communication devices, a differential-mode signal and a common-mode signal simultaneously through non-contact coupling between the first and second coupling elements.

### Embodiment A2

The wireless communication system described in Embodiment A1, wherein

the differential-mode signal is a baseband signal, and

the common-mode signal is a modulated carrier wave signal.

### Embodiment A3

The wireless communication system described in Embodiment A1, wherein

the differential-mode signal is a baseband signal, and

the common-mode signal is a sine wave signal, or a band-limited rectangular-wave signal whose bandwidth is limited in comparison to that of the baseband signal.

### Embodiment A4

The wireless communication system described in Embodiment A2 or A3, wherein a center frequency of the carrier wave signal, the sine wave signal, or the band-limited rectangular-wave signal is substantially equal to a half of a bit-rate of the baseband signal or substantially equal to an integral multiple of the half of the bit-rate of the baseband signal.

### Embodiment A5

The wireless communication system described in Embodiment A4, wherein a phase of the carrier wave signal, the sine wave signal, or the band-limited rectangular-wave signal is shifted from a phase of the baseband signal by 90 electrical degrees.

### Embodiment A6

The wireless communication system described in any one of Embodiments A1 to A5, wherein

the first communication device includes a differential-mode transmitter that supplies the differential-mode signal to the first signal line pair,

the second communication device includes a differential-mode receiver that receives the differential-mode signal through the first and second coupling elements,

one of the first and second communication devices includes a common-mode transmitter that supplies the common-mode signal to the first or second signal line pair, and

the other of the first and second communication devices includes a common-mode receiver that receives the common-mode signal through the first and second coupling elements.

### Embodiment A7

The wireless communication system described in any one of Embodiments A1 to A6, wherein

the first coupling element includes a first inductor including a first conductive loop,

the second coupling element includes a second inductor including a second conductive loop, and

the first and second coupling elements are arranged so that the first and second conductive loops face each other, and thereby form the non-contact coupling.

### Embodiment A8

The wireless communication system described in Embodiment A7, wherein

the first communication device is configured to drive both ends of the first conductive loop by two signals having mutually-opposite phases and constituting the differential-mode signal, and

the first or second communication device is configured to drive both ends of the first or second conductive loop by two signals having same phase and constituting the common-mode signal.

### Embodiment A9

The wireless communication system described in Embodiment A7 or A8, wherein each of the first and second inductors is formed by a printed wiring on a wiring board, a lead frame inside a semiconductor package, or a wiring layer on a semiconductor substrate.

### Embodiment A10

The wireless communication system described in any one of Embodiments A7 to A9, wherein

each of the first and second conductive loops has an axial-symmetric shape, and

the first and second inductors are arranged so that a plane containing a symmetry axis of the first conductive loop is in parallel with a plane containing a symmetry axis of the second conductive loop.

### Embodiment A11

The wireless communication system described in Embodiment A10, wherein the first conductive loop has an identical shape to that of the second conductive loop.

### Embodiment A12

The wireless communication system described in any one of Embodiments A1 to A11, wherein

the non-contact coupling includes inductive coupling and capacitive coupling,

the differential-mode signal is transmitted mainly by the inductive coupling between the first and second coupling elements, and

the common-mode signal is transmitted mainly by the capacitive coupling between the first and second coupling elements.

### Embodiment A13

The wireless communication system described in any one of Embodiments A1 to A12, wherein at least one of the first and second communication devices is configured to wake up a circuit for transmitting or receiving the differential-mode signal in response to successful transmission of the common-mode signal.

### Embodiment A14

The wireless communication system described in any one of Embodiments A1 to A13, wherein the second communication device is configured to transmit, by using the common-mode signal, control data used for a transmission power adjustment of the differential-mode signal in the first communication device.

### Embodiment A15

The wireless communication system described in any one of Embodiments A1 to A14, wherein at least one of the first and second communication devices is configured to display, on a display device, information for urging a user to adjust arrangements of the first communication device and the first coupling element or arrangements of the second communication device and the second coupling element, in response to insufficient reception quality of the common-mode signal or the differential-mode signal.

### Embodiment A16

The wireless communication system described in Embodiment A6, wherein the common-mode receiver includes a rectifier that rectifies the common-mode signal received by the common-mode receiver.

### Embodiment A17

A wireless communication apparatus including:

a first communication device; and

a first coupling element connected to the first communication device through a first signal line pair, wherein

the first communication device is configured to perform simultaneous wireless transmission of a differential-mode signal and a common-mode signal with another wireless communication apparatus through non-contact coupling between the first coupling element and a second coupling element provided in the anther wireless communication apparatus.

### Embodiment A18

The wireless communication apparatus described in Embodiment A17, wherein

the differential-mode signal is a baseband signal, and

the common-mode signal is a modulated carrier wave signal.

### Embodiment A19

The wireless communication apparatus described in Embodiment A17, wherein

the differential-mode signal is a baseband signal, and

the common-mode signal is a sine wave signal, or a band-limited rectangular-wave signal whose bandwidth is limited in comparison to that of the baseband signal.

### Embodiment A20

The wireless communication apparatus described in Embodiment A18 or A19, wherein a center frequency of the carrier wave signal, the sine wave signal, or the band-limited rectangular-wave signal is substantially equal to a half of a bit-rate of the baseband signal or substantially equal to an integral multiple of the half of the bit-rate of the baseband signal.

### Embodiment A21

The wireless communication apparatus described in Embodiment A20, wherein a phase of the carrier wave signal, the sine wave signal, or the band-limited rectangular-wave signal is shifted from a phase of the baseband signal by 90 electrical degrees.

### Embodiment A22

The wireless communication apparatus described in any one of Embodiments A17 to A21, wherein the first communication device includes:

at least one of a differential-mode transmitter that supplies the differential-mode signal to the first signal line pair and a differential-mode receiver that receives the differential-mode signal from the first signal line pair; and

at least one of a common-mode transmitter that supplies the common-mode signal to the first signal line pair and a common-mode receiver that receives the common-mode signal from the first signal line pair.

### Embodiment A23

The wireless communication apparatus described in any one of Embodiments A17 to A22, wherein

the first coupling element includes a first inductor including a first conductive loop,

the second coupling element includes a second inductor including a second conductive loop, and

the first coupling element is disposed so that the first and second conductive loops face each other, and thereby forms the non-contact coupling.

### Embodiment A24

The wireless communication apparatus described in Embodiment A23, wherein

the first communication device is configured to drive both ends of the first conductive loop by two signals having mutually-opposite phases and constituting the differential-mode signal, or is configured to receive the differential-mode signal from both ends of the first conductive loop, and

the first communication device is further configured to drive both ends of the first conductive loop by two signals having the same phase and constituting the common-mode signal, or is configured to receive the common-mode signal from both ends of the first conductive loop.

### Embodiment A25

The wireless communication apparatus described in Embodiment A23 or A24, wherein the first inductor is formed by a printed wiring on a wiring board, a lead frame inside a semiconductor package, or a wiring layer on a semiconductor substrate.

### Embodiment A26

The wireless communication apparatus described in any one of Embodiments A23 to A25, wherein

each of the first and second conductive loops has an axial-symmetric shape, and

the first inductor is arranged so that a plane containing a symmetry axis of the first conductive loop is in parallel with a plane containing a symmetry axis of the second conductive loop.

### Embodiment A27

The wireless communication apparatus described in Embodiment A26, wherein the first conductive loop has an identical shape to that of the second conductive loop.

### Embodiment A28

The wireless communication apparatus described in any one of Embodiments A17 to A27, wherein

the non-contact coupling includes inductive coupling and capacitive coupling,

the differential-mode signal is transmitted mainly by the inductive coupling between the first and second coupling elements, and

the common-mode signal is transmitted mainly by the capacitive coupling between the first and second coupling elements.

### Embodiment A29

The wireless communication apparatus described in any one of Embodiments A17 to A28, wherein the first communication device is configured to wake up a circuit for transmitting or receiving the differential-mode signal in response to successful transmission of the common-mode signal.

### Embodiment A30

The wireless communication apparatus described in any one of Embodiments A17 to A29, wherein the first communication device is configured to transmit or receive, by using the common-mode signal, control data used for a transmission power adjustment of the differential-mode signal.

### Embodiment A31

The wireless communication apparatus described in any one of Embodiments A17 to A30, wherein the wireless communication apparatus is configured to display, on a display device, information for urging a user to adjust an arrangement of the wireless communication apparatus or an arrangement of the another wireless communication apparatus, in response to insufficient reception quality of the common-mode signal or the differential-mode signal.

### Embodiment A32

The wireless communication apparatus described in Embodiment A22, wherein the common-mode receiver includes a rectifier that rectifies the common-mode signal received by the common-mode receiver.

### Embodiment A33

A wireless communication method including:

arranging first and second wireless communication apparatuses so that a first coupling element in the first wireless communication apparatus and a second coupling element in the second wireless communication apparatus form non-contact coupling; and

wirelessly transmitting a differential-mode signal and a common-mode signal simultaneously between the first and second wireless communication apparatuses through the non-contact coupling.

### Embodiment A34

The wireless communication method described in Embodiment A33, wherein

the differential-mode signal is a baseband signal, and

the common-mode signal is a modulated carrier wave signal.

### Embodiment A35

The wireless communication method described in Embodiment A33, wherein

the differential-mode signal is a baseband signal, and

the common-mode signal is a sine wave signal, or a band-limited rectangular-wave signal whose bandwidth is limited in comparison to that of the baseband signal.

### Embodiment A36

The wireless communication method described in Embodiment A34 or A35, wherein a center frequency of the carrier wave signal, the sine wave signal, or the band-limited rectangular-wave signal is substantially equal to a half of a bit-rate of the baseband signal or substantially equal to an integral multiple of the half of the bit-rate of the baseband signal.

### Embodiment A37

The wireless communication method described in Embodiment A36, wherein a phase of the carrier wave signal, the sine wave signal, or the band-limited rectangular-wave signal is shifted from a phase of the baseband signal by 90 electrical degrees.

### Embodiment A38

The wireless communication method described in any one of Embodiments A33 to A37, wherein

the first coupling element includes a first inductor including a first conductive loop,

the second coupling element includes a second inductor including a second conductive loop, and

the arranging includes arranging the first and second wireless communication apparatuses so that the first and second conductive loops face each other.

### Embodiment A39

The wireless communication method described in any one of Embodiments A33 to A38, wherein the wirelessly transmitting includes:

Supplying, by the first wireless communication apparatuses, the differential-mode signal to two ports of the first inductor; and

supplying, by the first or second wireless communication apparatuses, the common-mode signal to two ports of the first or second inductor.

### Embodiment A40

The wireless communication method described in Embodiment A38 or A39, wherein

each of the first and second conductive loops has an axial-symmetric shape, and

the arranging includes arranging the first and second wireless communication apparatuses so that a plane containing a symmetry axis of the first conductive loop is in parallel with a plane containing a symmetry axis of the second conductive loop.

### Embodiment A41

The wireless communication method described in Embodiment A40, wherein the first conductive loop has an identical shape to that of the second conductive loop.

### Embodiment A42

The wireless communication method described in any one of Embodiments A33 to A41, wherein

the non-contact coupling includes inductive coupling and capacitive coupling,

the differential-mode signal is transmitted mainly by the inductive coupling between the first and second coupling elements, and

the common-mode signal is transmitted mainly by the capacitive coupling between the first and second coupling elements.

### Embodiment A43

The wireless communication method described in any one of Embodiments A33 to A42, further including waking up, by at least one of the first and second wireless communication apparatuses, a circuit for transmitting or receiving the differential-mode signal in response to successful transmission of the common-mode signal.

### Embodiment A44

The wireless communication method described in any one of Embodiments A33 to A43, further including transferring, between the first and second wireless communication apparatuses by using the common-mode signal, control data used for a transmission power adjustment of the differential-mode signal.

### Embodiment A45

The wireless communication method described in any one of Embodiments A33 to A44, further including displaying, on a display device, information for urging a user to adjust an arrangement of the first or second wireless communication apparatus, in response to insufficient reception quality of the common-mode signal or the differential-mode signal.

### Embodiment A46

The wireless communication method described in any one of Embodiments A33 to A45, further including rectifying the common-mode signal with a rectifier at the first or second wireless communication apparatus that has received the common-mode signal.

What is claimed is:

1. A wireless communication system comprising:
first and second communication devices;
a first coupling element connected to the first communication device through a first signal line pair; and
a second coupling element connected to the second communication device through a second signal line pair, wherein
the first and second communication devices are configured to wirelessly transmit, between the first and second communication devices, a differential-mode signal and a common-mode signal simultaneously through non-contact coupling between the first and second coupling elements.

2. The wireless communication system according to claim 1, wherein
the differential-mode signal is a baseband signal, and
the common-mode signal is a modulated carrier wave signal.

3. The wireless communication system according to claim 1, wherein
the differential-mode signal is a baseband signal, and
the common-mode signal is a sine wave signal, or a band-limited rectangular-wave signal whose bandwidth is limited in comparison to that of the baseband signal.

4. The wireless communication system according to claim 1, wherein
the first coupling element comprises a first inductor including a first conductive loop,
the second coupling element comprises a second inductor including a second conductive loop, and
the first and second coupling elements are arranged so that the first and second conductive loops face each other, and thereby form the non-contact coupling.

5. A wireless communication apparatus comprising:
a first communication device; and
a first coupling element connected to the first communication device through a first signal line pair, wherein
the first communication device is configured to perform simultaneous wireless transmission of a differential-mode signal and a common-mode signal with another wireless communication apparatus through non-contact coupling between the first coupling element and a second coupling element provided in the anther wireless communication apparatus.

6. The wireless communication apparatus according to claim 5, wherein
the differential-mode signal is a baseband signal, and
the common-mode signal is a modulated carrier wave signal.

7. The wireless communication apparatus according to claim 5, wherein
the differential-mode signal is a baseband signal, and
the common-mode signal is a sine wave signal, or a band-limited rectangular-wave signal whose bandwidth is limited in comparison to that of the baseband signal.

8. The wireless communication apparatus according to claim 7, wherein a center frequency of the carrier wave signal, the sine wave signal, or the band-limited rectangular-wave signal is substantially equal to a half of a bit-rate of the baseband signal or substantially equal to an integral multiple of the half of the bit-rate of the baseband signal.

9. The wireless communication apparatus according to claim 8, wherein a phase of the carrier wave signal, the sine wave signal, or the band-limited rectangular-wave signal is shifted from a phase of the baseband signal by 90 electrical degrees.

10. The wireless communication apparatus according to claim 5, wherein the first communication device comprises:
at least one of a differential-mode transmitter that supplies the differential-mode signal to the first signal line pair and a differential-mode receiver that receives the differential-mode signal from the first signal line pair; and
at least one of a common-mode transmitter that supplies the common-mode signal to the first signal line pair and a common-mode receiver that receives the common-mode signal from the first signal line pair.

11. The wireless communication apparatus according to claim 5, wherein
the first coupling element comprises a first inductor including a first conductive loop,
the second coupling element comprises a second inductor including a second conductive loop, and
the first coupling element is disposed so that the first and second conductive loops face each other, and thereby forms the non-contact coupling.

12. The wireless communication apparatus according to claim 11, wherein
the first communication device is configured to drive both ends of the first conductive loop by two signals having mutually-opposite phases and constituting the differential-mode signal, or is configured to receive the differential-mode signal from both ends of the first conductive loop, and
the first communication device is further configured to drive both ends of the first conductive loop by two signals having the same phase and constituting the common-mode signal, or is configured to receive the common-mode signal from both ends of the first conductive loop.

13. The wireless communication apparatus according to claim 11, wherein the first inductor is formed by a printed wiring on a wiring board, a lead frame inside a semiconductor package, or a wiring layer on a semiconductor substrate.

14. The wireless communication apparatus according to claim 11, wherein
each of the first and second conductive loops has an axial-symmetric shape, and
the first inductor is arranged so that a plane containing a symmetry axis of the first conductive loop is in parallel with a plane containing a symmetry axis of the second conductive loop.

15. The wireless communication apparatus according to claim 14, wherein the first conductive loop has an identical shape to that of the second conductive loop.

16. The wireless communication apparatus according to claim 5, wherein
the non-contact coupling includes inductive coupling and capacitive coupling,
the differential-mode signal is transmitted mainly by the inductive coupling between the first and second coupling elements, and
the common-mode signal is transmitted mainly by the capacitive coupling between the first and second coupling elements.

17. The wireless communication apparatus according to claim 5, wherein the first communication device is configured to wake up a circuit for transmitting or receiving the differential-mode signal in response to successful transmission of the common-mode signal.

18. The wireless communication apparatus according to claim 5, wherein the first communication device is configured to transmit or receive, by using the common-mode signal, control data used for a transmission power adjustment of the differential-mode signal.

19. The wireless communication apparatus according to claim 17, wherein the wireless communication apparatus is configured to display, on a display device, information for urging a user to adjust an arrangement of the wireless communication apparatus or an arrangement of the another wireless communication apparatus, in response to insufficient reception quality of the common-mode signal or the differential-mode signal.

20. The wireless communication apparatus according to claim 10, wherein the common-mode receiver comprises a rectifier that rectifies the common-mode signal received by the common-mode receiver.
